(19) United States
(12) Patent Application Publication
(10) Pub. No.: US 2026/0038190 A1
(43) Pub. Date: Feb. 5, 2026

(54) FILTERING THREE-DIMENSIONAL SHAPE DATA FOR TRAINING TEXT TO 3D GENERATIVE AI SYSTEMS AND APPLICATIONS

(71) Applicant: NVIDIA Corporation, Santa Clara, CA (US)

(72) Inventors: Zekun Hao, Santa Clara, CA (US); Yin Cui, Mountain View, CA (US); Fangyin Wei, Santa Clara, CA (US); Yunhao Ge, Sunnyvale, CA (US); Yifan Ding, Mountain View, CA (US); Xiaohui Zeng, Toronto (CA); Tsung-Yi Lin, Sunnyvale, CA (US); Chen-Hsuan Lin, San Jose, CA (US); Ming-Yu Liu, Redwood City, CA (US)

(21) Appl. No.: 18/790,413

(22) Filed: Jul. 31, 2024

(51) Int. Cl. G06T 15/20; G06T 7/00; G06T 7/593

(52) U.S. Cl. CPC G06T 15/20; G06T 7/0002; G06T 7/593; G06T 2200/04; G06T 2207/20081; G06T 2207/30168

(57) ABSTRACT

In various examples, techniques for performing data filtering for AI systems and applications is described herein. Systems and methods described herein may use a pipeline that is configured to filter shapes, such as three-dimensional shapes, in order to identify high-quality shapes for a final dataset. In some examples, to identify the high-quality shapes, training shapes along with ground truth scores associated with the training shapes may be used to train a machine learning model. During and/or after the training, the machine learning model may then be used to process data associated with additional shapes in order to determine quality scores associated with the additional shapes. These quality scores may then be used to select the high-quality shapes, such as shapes that satisfy a threshold quality score. In some examples, additional filtering may be performed by the pipeline, such as by using one or more rules for removing low-quality shapes.

### BACKGROUND

Efficient and effective data curation is critical for many tasks, such as in the generation of high-quality datasets of images for training machine learning models. Conventional data curation systems use human feedback to organize and integrate data that is collected from various sources. Additionally, conventional systems often use human feedback to annotate, publish, and/or present the data using one or more formats. As such, these conventional systems may require a large amount of human resources and/or time in order to generate a high-quality dataset. Additionally, the generation of the high-quality dataset may be prone to human error when performing each of these processing tasks.

For example, when generating a final dataset of images representing different shapes, users may need to analyze large numbers of images, such as over hundreds of thousands and/or millions of images that represents three-dimensional shapes, in order to identify and select images that represent high-quality shapes to include in the final dataset. The users may then need to annotate each of the images in the final dataset, such as by adding captions describing the shapes in detail. Additionally, in circumstances where the final dataset may be used to train machine learning models, training performance may improve when the images represent the shapes using a consistent and/or similar view. As such, the users may need to further set and/or select the respective view of each of the shapes when rendering the images that are included in the final dataset.

Furthermore, in some circumstances, based on the amount of user feedback that is needed to generate the final dataset of images, errors may occur during one or more of the processing tasks. For example, users may make errors when selecting the high-quality shapes, when describing the high-quality shapes using captions, and/or when setting and/or selecting poses for rendering the images. Additionally, since data curation may work in a pipeline where the processing tasks are performed interdependently, when users make errors during an initial processing task, those errors may be carried through and/or cause additional errors in later processing tasks.

### SUMMARY

Embodiments of the present disclosure relate to using processing pipelines to perform data filtering, alignment, annotation, and/or rendering for AI systems and applications. Systems and methods described herein may use one or more pipelines that automatically curate and annotate data, such as two-dimensional (2D) data and/or three-dimensional (3D) data representing 3D shapes (e.g., of shapes of objects, subjects, and/or their components). For instance, in some examples, a first pipeline (e.g., a “filtering pipeline”) may use a trained machine learning model to determine quality scores associated with shapes represented by an initial dataset, where the filtering pipeline then uses the quality scores to filter the initial dataset and to select shapes that satisfy a quality threshold. In some examples, a second pipeline (e.g., a “pose-alignment pipeline”) may use a trained machine learning model to determine poses associated with the initial dataset and/or the filtered dataset, where the pose-aligned pipeline then uses the poses to align the shapes using a common pose (e.g., a canonical view) for a final dataset. Still, in some examples, a third pipeline (e.g., an “annotation pipeline”) may use a trained machine learning model to annotate the final dataset, such as with one or more captions. As such, the systems and methods of the present disclosure may use these pipelines to perform automatic data filtering, pose alignment, data annotation, and/or data rendering.

In contrast to conventional systems, such as those described above, the systems of the present disclosure, in some embodiments, are able to automatically perform data curation and/or annotation in order to generate a final dataset. As such, the systems of the present disclosure may reduce the amount of human resources and/or time needed to generate the final dataset, as compared to the conventional systems. Additionally, in some embodiments, the systems of the present disclosure may generate more accurate datasets as compared to the conventional systems by using the trained models. For instance, and as described in more detail herein, the models may be trained using accurate training sets and/or over multiple iterations such that the models, either during and/or after training, may accurately determine quality scores, poses, and/or annotations for shapes. In contrast, and as described herein, by using user inputs during data curation, the conventional systems may be prone to user error when determining quality shapes, shape poses, and/or shape annotations, which may reduce the accuracy of the final dataset.

### BRIEF DESCRIPTION OF THE DRAWINGS

The present systems and methods for using processing pipelines to perform data filtering, alignment, annotation, and/or rendering for AI systems and applications are described in detail below with reference to the attached drawing figures, wherein:

FIG. 1 illustrates an example of a process for performing data curation and annotation, in accordance with some embodiments of the present disclosure;

FIG. 2A illustrates an example of a filtering pipeline that filters shapes, in accordance with some embodiments of the present disclosure;

FIG. 2B illustrates an example of rendering different views of a shape, where the views may be used to train a scoring model(s) and/or score the shape, in accordance with some embodiments of the present disclosure;

FIG. 2C illustrates a data flow diagram illustrating a process for training a scoring model(s), in accordance with some embodiments of the present disclosure;

FIG. 2D illustrates an example of ranking an initial set of shapes and then filtering the initial set of shapes based at least on the rankings, in accordance with some embodiments of the present disclosure;

FIG. 3A illustrates an example of a 3D-alignment pipeline that aligns shapes, in accordance with some embodiments of the present disclosure;

FIG. 3B illustrates an example of rendering a shape using different views, in accordance with some embodiments of the present disclosure;

FIG. 3C illustrates a data flow diagram illustrating a process for training a 3D-pose model(s), in accordance with some embodiments of the present disclosure;

FIG. 3D illustrates an example of using pose information to align shapes with respect to one another, in accordance with some embodiments of the present disclosure;

FIG. 4A illustrates an example of a 2D-alignment pipeline that aligns shapes, in accordance with some embodiments of the present disclosure;

FIG. 4B illustrates an example of rendering images of a shape, where the images are associated with different azimuth angles, in accordance with some embodiments of the present disclosure;

FIG. 4C illustrates a data flow diagram illustrating a process for training a 2D-pose model(s), in accordance with some embodiments of the present disclosure;

FIG. 4D illustrates an example of using poses to align shapes with respect to one another, in accordance with some embodiments of the present disclosure;

FIG. 5A illustrates an example of an annotation pipeline that generates annotations associated with shapes, in accordance with some embodiments of the present disclosure;

FIG. 5B illustrates an example of generating annotations associated with a shape, in accordance with some embodiments of the present disclosure;

FIG. 6 illustrates an example of a rendering pipeline that generates images using pose data, in accordance with some embodiments of the present disclosure;

FIG. 7 illustrates a flow diagram showing a method for filtering images depicting shapes based at least on qualities scores associated with the shapes, in accordance with some embodiments of the present disclosure;

FIG. 8 illustrates a flow diagram showing a method for determining poses associated with images depicting views of shapes and/or aligning the shapes based at least on the poses, in accordance with some embodiments of the present disclosure;

FIG. 9 illustrates a flow diagram showing a method for generating annotations associated with images of shapes, in accordance with some embodiments of the present disclosure;

FIG. 10 illustrates a flow diagram showing a method for performing data curation and annotation, in accordance with some embodiments of the present disclosure;

FIG. 11 is a block diagram of an example computing device suitable for use in implementing some embodiments of the present disclosure;

FIG. 12 is a block diagram of an example data center suitable for use in implementing some embodiments of the present disclosure;

FIG. 13A is a block diagram of an example generative language model system suitable for use in implementing some embodiments of the present disclosure;

FIG. 13B is a block diagram of an example generative language model that includes a transformer encoder-decoder suitable for use in implementing some embodiments of the present disclosure; and

FIG. 13C is a block diagram of an example generative language model that includes a decoder-only transformer architecture suitable for use in implementing some embodiments of the present disclosure.

### DETAILED DESCRIPTION

Systems and methods are disclosed related to using processing pipelines to perform data filtering, alignment, annotation, and/or rendering for AI systems and applications. For instance, a system(s) may receive data (e.g., raw data) representing assets, such as data (referred to, in some examples, as “2D data”) representing images of shapes, data (referred to, in some examples, as “3D data”) representing 3D information for rendering shapes, data representing scenes that include multiple shapes, and/or any other type of data. In some examples, the system(s) may then convert the data to a uniform data format for later processing. For instance, the raw data may initially represent multiple file formats (e.g., geometry definition file format, propriety data format, GL Transmission File Format files, MAX file format, 3DS file format, USD file format, etc.), include multiple files under a same identifier (e.g., asset identifier), and/or include files with multiple shapes. As such, the system(s) may initially convert at least a portion of the files represented by the raw data to a single, converted file format (e.g., the GPB files). When performing the conversion, the system(s) may further perform one or more processes to preserve scene graphs, texture, and/or annotations associated with the assets, which is described in more detail herein.

In some examples, the system(s) may then use a pipeline (referred to, in some examples, as a “filtering pipeline”) to filter at least a portion of the data (e.g., the raw data, the converted data, etc.) to remove shapes from the initial set of shapes that do not satisfy a quality threshold. For instance, the system(s) may generate, receive, retrieve, obtain, and/or determine a training set that includes training images representing high-quality shapes, training images that represent low-quality shapes, and/or ground truth data that annotates the training images with quality scores associated with the shapes. As described herein, the quality scores may be within a range, such as 0 and 1 (and/or any other range), where the quality scores increase with the quality of the shapes. For a first example, the ground truth data may represent the highest quality score for the high-quality shapes, such as 1, and the lowest quality score for the low-quality shapes, such as 0. For a second example, the ground truth data may represent quality scores between 0 and 1 that represent actual qualities of the shapes, such as determined using one or more users. In either example, the filtering pipeline may then perform any technique to train one or more machine learning models (referred to, in some examples, as a “scoring model(s)”) using the training set, which is described in more detail herein.

After performing this initial training, the filtering pipeline may then use the scoring model(s) to determine quality scores associated with the shapes. For instance, and for a shape, the filtering pipeline may include rendering the shape using one or more images, where each image may represent a respective view of the shape with respect to a camera. For example, the shape may be rendered using four images, where each image is associated with a camera being placed on a top of a bounding shape (e.g., a bounding box) associated with the shape and oriented towards an origin of the shape. The filtering pipeline may then generate one or more embeddings associated with the image(s), such as an individual embedding for each image and/or a single embedding for all of the image(s). The scoring model(s) may then process the embedding(s) and, based at least on the processing, output the quality score associated with the shape. Additionally, the filtering pipeline may perform similar processes for one or more additional shapes (e.g., each of the shapes) represented by the 3D data.

The filtering pipeline may then rank the shapes based at least on the quality scores, such as by ranking the shapes from the lowest-quality shape to the highest-quality shape and/or the highest-quality shape to the lowest-quality shape. In some examples, the filtering pipeline may then use the quality scores and/or the rankings to select one or more additional shapes to include in the training set, such as shapes for which the quality scores are inaccurate (e.g., a low-quality shape that was ranked high, a medium-quality shape that was ranked low or high, a high-quality shape that was ranked low, etc.). Additionally, using the updated training set, the filtering pipeline may then further train the scoring model(s) in order to increase the accuracy of the scoring model(s) when processing images. These processes may then continue to repeat until the occurrence of one or more events, such as a threshold number of iterations occurring, the scoring model(s) satisfying an accuracy threshold, and/or any other event occurring.

Additionally, in some examples, the filtering pipeline may use the quality scores and/or the rankings to select one or more shapes to include in an initial subset of the shapes. For instance, the filtering pipeline may select shapes that are associated with quality scores that satisfy (e.g., are equal to or greater than) a threshold score. In some examples, the filtering pipeline may use a predetermined threshold score to perform the filtering, such as 0.7, 0.8, 0.9, 0.95, and/or any other score. Additionally, or alternatively, in some examples, the filtering pipeline may dynamically determine the threshold score, such as by using the quality scores associated with the shapes. For example, the filtering pipeline may determine a distribution associated with the quality scores, such as a histogram (and/or any other type of distribution), and then use the distribution to determine the threshold score. This way, the filtering pipeline may ensure that the final dataset includes at least a threshold number of shapes.

In some examples, the filtering pipeline may use one or more rules to further filter the shapes, such as the high-quality shapes, to determine a final subset of shapes (e.g., a final dataset). For example, the filtering pipeline may use a rule to remove corrupted shapes, a rule to remove shapes that are associated with large scenes, a rule to remove shapes that are associated with scenes that include one or more additional shapes, a rule to remove shapes that represent ground planes, a rule to remove shapes that represent backdrops, and/or using any other rule. In any of these examples, the output from the filtering pipeline may include data (which may be referred to, in some examples, as “filtered data”) that represents the high-quality shapes from the initial data.

In some examples, the system(s) may then use a pipeline (e.g., referred to, in some examples, as a “3D-alignment pipeline”) to align the shapes represented by the filtered data (e.g., the filtered 3D data). For instance, the system(s) may generate, receive, retrieve, obtain, and/or determine a training set that includes a number of training images that represent shapes along with ground truth data that annotates the training images with information indicating the poses of the shapes as represented by the training images. In some examples, the training set may include multiple training images that represent a single shape, where each training image is associated with a respective pose. For example, the training set may include five training images that represent the shape in five poses, ten training images that represent the shape in ten poses, and/or any other number of training images. Additionally, since these shapes are associated with the 3D data, a pose may be associated with a gravity orientation and/or an azimuth angle. The 3D-alignment pipeline may then perform any technique to train one or more machine learning models (referred to, in some examples, as a “3D-pose model(s)”) using the training set, which is described in more detail herein.

After performing this initial training, the 3D-alignment pipeline may then use the 3D-pose model(s) to determine poses associated with images for additional shapes represented by the filtered data. For instance, and for a shape, the 3D-alignment pipeline may render one or more images that represent the shape using one or more views, where each view may again represent the shape in a respective pose. For example, the shape may be rendered using forty-eight images (and/or any other number of images), where each image is associated with a respective gravity orientation and/or a respective azimuth angle for the shape. The 3D-alignment pipeline may then generate one or more embeddings associated with the image(s), such as an individual embedding for each image and/or a single embedding for all of the image(s). The 3D-pose model(s) may then process the embedding(s) and, based at least on the processing, output the pose(s) associated with the image(s) of the shape. Additionally, the 3D-alignment pipeline may perform similar processes for one or more additional shapes (e.g., each of the shapes) represented by the filtered data.

In some examples, the 3D-alignment pipeline may then use the poses to select one or more additional shapes to include in the training set, such as shapes for which the poses are inaccurate (e.g., a gravity orientation and/or an azimuth angle associated with a shape is inaccurate). Additionally, using the updated training set, the 3D-alignment pipeline may then further train the 3D-pose model(s) in order to increase the accuracy of the 3D-pose model(s) when processing images. These processes may then continue to repeat until the occurrence of one or more events, such as a threshold number of iterations occurring, the 3D-pose model(s) satisfying an accuracy threshold, and/or any other event occurring. In some examples, while still training the 3D-pose model(s) and/or after training the 3D-pose model(s), the 3D-alignment pipeline may generate and/or output data (which may be referred to, in some examples, as “3D-pose data”) representing the poses associated with the images of the shapes.

In some examples, the 3D-alignment pipeline may perform additional processes with regard to shapes using the poses. For instance, the 3D-alignment pipeline may align the shapes with respect to one another using the poses, such that the shapes include a consistent and/or similar pose (e.g., a reference pose, a canonical pose, etc.). In examples where the 3D-alignment pipeline aligns the shapes, the 3D-pose data may further represent the views of the shapes that align the shapes with one another and/or represent images of the shapes aligned with one another.

In some examples, such as to process the 2D data, the system(s) may use a pipeline (e.g., referred to, in some examples, as a “2D-alignment pipeline”) to align the images of the shapes represented by the 2D data. For instance, the system(s) may generate, receive, retrieve, obtain, and/or determine a training set that includes a number of training images that represent shapes along with ground truth data that annotates the training images with information indicating the poses of the shapes as represented by the training images. In some examples, the training set may include multiple training images that represent a single shape, where each training image is associated with a respective pose. For example, the training set may include two training images that represent the shape in two poses, three training images that represent the shape in three poses, four training images that represent the shape in four poses, five training images that represent the shape in five poses, and/or any other number of training images. Additionally, since this is 2D data, a pose may be associated with an elevation and/or an azimuth angle. The 2D-alignment pipeline may then perform any technique to train one or more machine learning models (referred to, in some examples, as a “2D-pose model(s)”) using the training set, which is described in more detail herein.

After performing this initial training, the 2D-alignment pipeline may then use the 2D-pose model(s) to determine poses associated with additional images that represent additional shapes. For instance, and for a shape, the 2D-alignment pipeline may identify one or more images that represent the shape using one or more views, where each view represents the shape in a respective pose. For example, the shape may be represented by four images (and/or any other number of images), where each image is associated with a respective azimuth angle view of the shape. The 2D-alignment pipeline may then generate one or more embeddings associated with the image(s), such as an individual embedding for each image and/or a single embedding for all of the image(s). The 2D-pose model(s) may then process the embedding(s) and, based at least on the processing, output the pose(s) associated with the image(s) of the shape. Additionally, the 2D-alignment pipeline may perform similar processes for one or more additional shapes (e.g., each of the shapes) represented by the 2D data.

In some examples, the 2D-alignment pipeline may then use the poses to select one or more additional images of one or more additional shapes to include in the training set, such as images for which the poses are inaccurate (e.g., an azimuth angle associated with a shape is inaccurate). Additionally, using the updated training set, the 2D-alignment pipeline may further train the 2D-pose model(s) in order to increase the accuracy of the 2D-pose model(s) when processing images. These processes may then continue to repeat until the occurrence of one or more events, such as a threshold number of iterations occurring, the 2D-pose model(s) satisfying an accuracy threshold, and/or any other event occurring.

In some examples, while still training the 2D-pose model(s) and/or after training the 2D-pose model(s), the 2D-alignment pipeline may generate and/or output data (which may be referred to, in some examples, as “2D-pose data”) representing the poses associated with the images of the shapes. Additionally, in some examples, the 2D-alignment pipeline may perform additional processes with regard to the images of the shapes. For instance, the 2D-alignment pipeline may align the images of the shapes with respect to one another using the poses, such that the images represent a consistent and/or similar pose (e.g., a reference pose, a canonical pose, etc.) for the shapes. In examples where the 2D-alignment pipeline aligns the images, the 2D-pose data may further represent the images of the shapes aligned with one another and/or the 2D data may represent orders for the images that align the shapes with respect to one another, which is described in more detail herein.

In some examples, the 2D-alignment pipeline may use one or more rules to filter the images of the shapes, such as rules associated with removing images of low-quality shapes. For instance, the 2D-alignment pipeline may use a rule to remove images that include a wrong gravity orientation for shapes, a rule to remove images that are associated with a similar shape identifier and multiple articulations, a rule to remove images with embeddings that include high similarities to embeddings of other images (e.g., neighboring shapes), and/or using any other rule. In any of these examples, the output from the 2D-alignment pipeline may include data (which may be referred to, in some examples, as “filtered 2D-pose data”) that represents aligned, high-quality shapes.

In some examples, the system(s) may use a pipeline (referred to, in some examples, as an “annotation pipeline”) to generate annotations associated with shapes, such as the shapes associated with the 3D-pose data and/or the shapes associated with the filtered 2D-pose data. For instance, the annotation pipeline may process the images and/or additional data representing descriptions associated with the shapes using one or more language models. As described herein, in some examples, a description associated with a shape may include text that describes the shape, such as an identifier (e.g., a name) of the shape, a category (e.g., type) of the shape, tags that represent characteristics (e.g., shape, size, color, texture, use, features, etc.) of the shape, information about parts of the shape, and/or any other information associated with the shape. Additionally, in some examples, the language model(s) may process additional data, such as data representing a format for the output of the language model(s). For example, the data may represent a format that includes generating both short captions and long captions for the shapes.

In some examples, to perform the processing for a shape, the annotation pipeline (and/or the language model(s)) may initially process the inputs, such as the image of the shape, the description of the shape, and/or the format, in order to generate input data for the language model(s), such as one or more input tokens. For example, the annotation pipeline may include processing the inputs using one or more machine learning models, one or more neural networks, one or more transformers, one or more components, one or more modules, and/or the like that are trained to generate the input data. The annotation pipeline may then apply the input data (e.g., in a tokenized format) to the language model(s) that is trained to process the input data. For instance, based at least on the processing, the language model(s) may output data, such as a tokenized representation, of one or more captions associated with the shape represented by the image. As described herein, the caption(s) may include a short caption that represents a first description of the shape, a long caption that represents a second description of the shape, and/or any other type of caption. The annotation pipeline may then include performing similar processes to annotate one or more additional shapes.

In some examples, the annotation pipeline may further use one or more processing components (e.g., one or more machine learning models, one or more neural networks, one or more transformers, one or more encoders, etc.) to generate embeddings for the captions. For a first example, such as when a shape is associated with both a short caption and a long caption, the processing component(s) may be configured to generate a first embedding associated with the short embedding and a second embedding associated with the long caption. For a second example, and again when a shape is associated with both a short caption and a long caption, the processing component(s) may be configured to generate a single embedding associated with a combination of the short caption and the long caption. In some examples, the annotation pipeline may then include associating the embeddings with the shapes.

In some examples, the system(s) may use a pipeline (referred to, in some examples, as a “rendering pipeline”) to render and/or select images associated with the shapes, such as the shapes associated with the 3D-pose data and/or the shapes associated with the filtered 2D-pose data. In some examples, when rendering and/or selecting the shapes, the rendering pipeline may be configured to render and/or select the shapes using a similar pose, such as a canonical pose. For a first example, and for the shapes associated with the 3D-pose data (referred to as “3D shapes in these examples for clarity reasons”), the rendering pipeline may include determining the canonical pose for the 3D shapes, determining intrinsic parameters associated with cameras based on the canonical pose and the poses representing by the 3D-pose data (e.g., elevations and azimuths associated with the camera), and then generating images that represent the 3D shapes oriented in the canonical pose using the camera parameters. For a second example, and for the shapes associated with the 2D-pose data (referred as “2D shapes in these examples for clarity reasons), the rendering pipeline may again include determining a canonical pose, but then selecting images that represent the 2D shapes oriented in the canonical pose using the poses represented by the filtered 2D-pose data.

In some examples, the rendering pipeline may include performing additional processes, such as aligning the images of the 3D shapes with the images of the 2D shapes. For instance, the rendering pipeline may include determining updated parameters associated with cameras used to generate the images of the 2D shapes using the parameters associated with the cameras used to generate the images of the 3D shapes and then updating the images of the 2D shapes using the updated parameters. For example, the updating of the images may include at least cropping the images such that the images representing the 2D shapes and the images representing the 3D shapes orient all of the shapes using the canonical pose. This way, even though the initial data may include both the 2D data representing shapes and the 3D data representing shapes, the final images represent the shapes using the same canonical pose and/or similar dimensions.

In some examples, the system(s) may then generate data that associates at least the rendered images of the shapes with the captions and/or the embeddings. This data may then be used by additional systems to perform additional tasks, such as to train machine learning models. For example, and as described in more detail herein, an additional system(s) may use the data to train a machine learning model to render shapes, such as 2D shapes and/or 3D shapes, using descriptions of the shapes. While this is just one example of how the data may be used to perform an additional task, in other examples, the data may be used to perform any other type of task.

As described herein, a model may include, be used by, and/or be associated with one or more neural networks, one or more classifiers, one or more algorithms, and/or any other type of processing component that is configured to perform at least a portion of the processes described herein. For instance, the scoring model(s) may be associated with a classifier that is trained to determine the quality scores associated with the shapes, the 3D-pose model(s) may be associated with a classifier that is trained to determine the gravity orientations associated with the shapes and/or a classifier that is trained to determine the azimuth angles associated with the shapes, and/or the 2D-pose model(s) may be associated with a classifier that is trained to determine the azimuth angles associated with the shapes.

Additionally, the examples herein describe using processing pipelines that include processing elements for performing various tasks, such as in a series and/or in parallel with one another. As described herein, a processing element may include a hardware element, a software element, an application, a set of instructions, a set of tasks, a model, an algorithm, a module, and/or any other type of processing component that is configured to perform at least a portion of the processes described herein.

Furthermore, the examples described herein are directed to performing data curation and/or annotation with regard to data representing shapes, such as 3D shapes. As described herein, a shape may include at least a portion of an object. For example, a may include, but is not limited to, a door of a vehicle, a vehicle, a building, an animal, a character, furniture, a traffic feature, and/or any other type of object. Additionally, in some examples, a shape may be designed and produced from real-world data, and/or may be synthetically produced, such as based on one or more simulations.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI 2operations, systems implemented at least partially using cloud computing resources, and/or other types of systems.

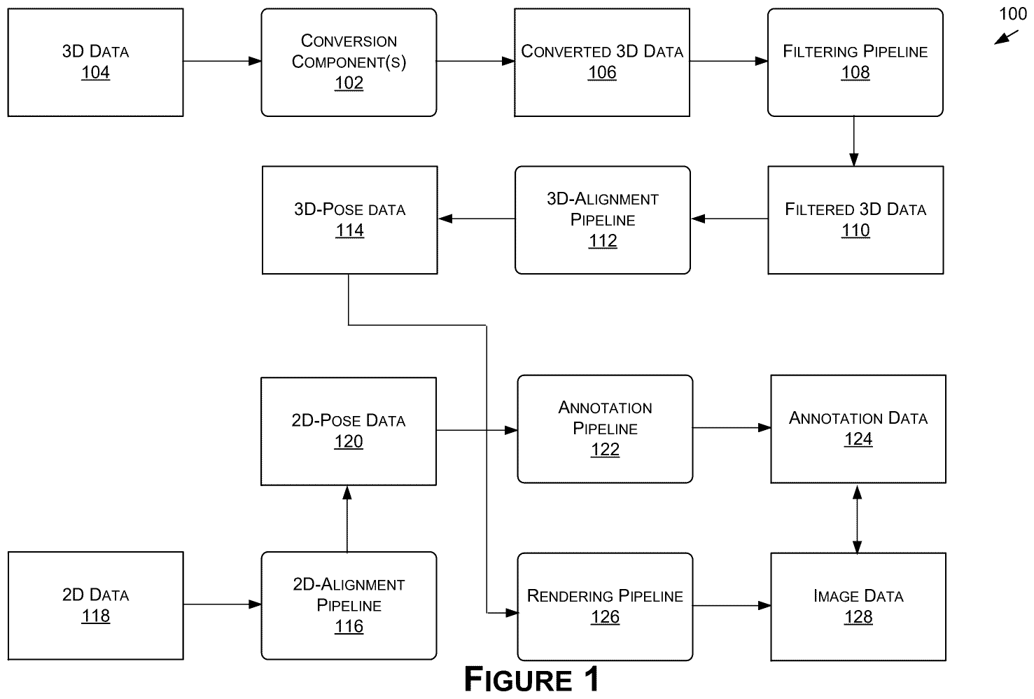

With reference to FIG. 1, FIG. 1 illustrates an example of a process 100 for performing data curation and annotation, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, the various functions and/or pipelines of the examples herein may be carried out by one or more example computing devices 1100, one or more example data centers 1200, and/or any other type of computing device and/or system. More specifically, and with regard to an example computing device 1100, the pipelines may be stored in memory 1104 and executed using one or more CPUs 1106, one or more GPU 1108, and/or any other type of processing unit.

The process 100 may include one or more conversion components 102 receiving 3D data 104 (e.g., raw 3D data) associated with 3D assets, such as scenes that include multiple shapes and/or individual shapes. As described herein, files represented by the 3D data 104 may be associated with one or more file formats such as, but not limited to, geometry definition file format, propriety data format, GLB file format, MAX file format, 3DS file format, USD file format, and/or any other type of file format. Additionally, in some examples, at least some files represented by the 3D data 104 may be associated with the same identifiers (e.g., asset identifiers) and/or at least some files represented by the 3D data 104 may include multiple shapes (e.g., the files may represent a scene with multiple shapes).

As such, such as to increase the performance of later processing, the process 100 may include the conversion component(s) 102 converting the files represented by the 3D data 104 to one or more specific file formats, where the converted files may be represented by converted 3D data 106. For example, the conversion component(s) 102 may convert the files represented by the 3D data 104 to GLB files (and/or any other file format) that represent the shapes. In some examples, when performing the conversion, the conversion component(s) 102 may further perform one or more processes to preserve scene graphs, texture, and/or annotations associated with the shapes. For example, the files represented by the converted 3D data 106 may be similar to the files represented by the 3D data 104, such as by representing the same shapes, textures, scene graphs, and/or annotations, but in a different format.

Additionally, in some examples, the conversion component(s) 102 may use one or more techniques to improve the conversion of the 3D data 104. For example, the 3D data 104 may represent both files that include the shapes (e.g., shape files) along with additional files needed to render the shapes, such as additional files that include textures associated with the shapes. As such, the conversion component(s) 102 may use one or more rules and/or algorithms that are able to search through the files and/or the file hierarchies in order to identify the additional files that match the shape files. For example, the conversion component(s) 102 may perform one or more iterations to find names of additional files that closely match path names indicated the shape files, where the path names indicate the additional files needed to render the shapes and/or the locations of the additional files.

The process 100 may include using a filtering pipeline 108 to process the converted 3D data 106 in order to remove one or more shapes from the set of shapes. As described herein, in some examples, the filtering pipeline 108 may remove at least a portion of the lower-quality shapes, such as shapes that are associated with quality scores that do not satisfy (e.g., are less than) a threshold score, while maintaining at least a portion of the higher-quality shapes, such as shapes that are associated with quality scores that satisfy (e.g., are equal to or greater than) the threshold score. In some examples, quality scores may be associated with one or more quality metrics that measure the accuracies of the shapes, such as metrics that measure accuracies of the dimensions of the shapes, accuracies of the textures of the shapes, accuracies of the orientations of the shapes, accuracies of the colors of the shapes, accuracies of the lines of the shapes (e.g., whether lines of the shapes are connected), accuracies of the parts of the shape (e.g., whether parts of the shapes are connected), and/or any other type of quality metric. As such, by filtering out the low-quality shapes, the filtering pipeline 108 may remove the shapes that include broken lines, incorrect texture, incorrect dimensions, and/or the like.

In some examples, the filtering pipeline 108 may perform additional processes for filtering the shapes, such as by using one or more rules for removing shapes. For example, the filtering pipeline 108 may use the rules to remove shapes that are corrupted, shapes that are associated with large scenes, shapes that are associated with scenes that include one or more additional shapes, shapes that represent ground planes, shapes that represent backdrops, and/or using any other rule. The filtering pipeline 108 may then generate and/or output filtered 3D data 110 representing a subset shapes from the set of shapes.

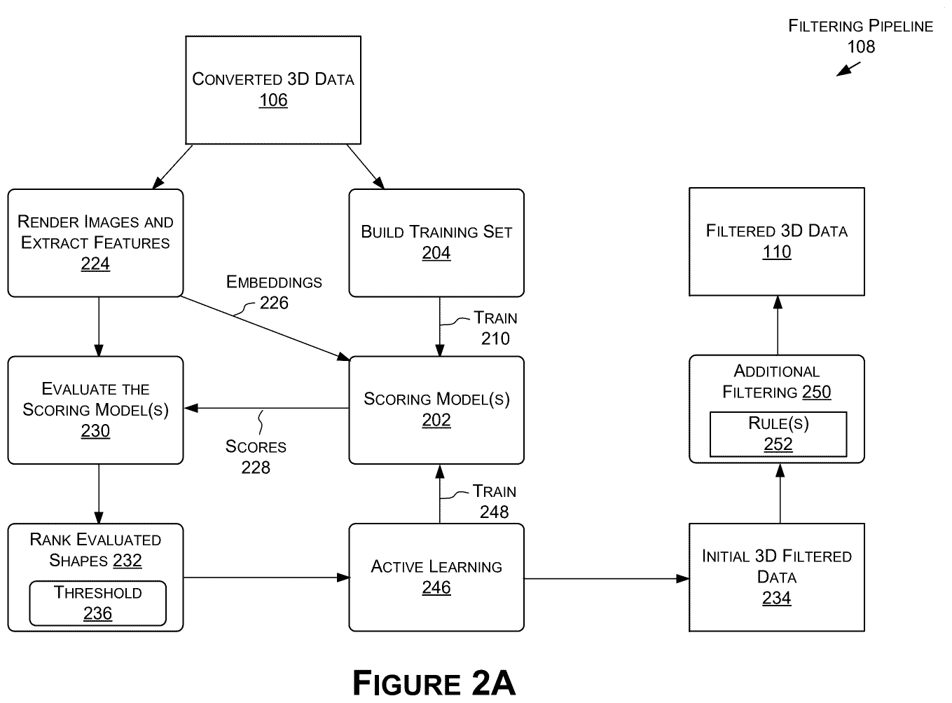

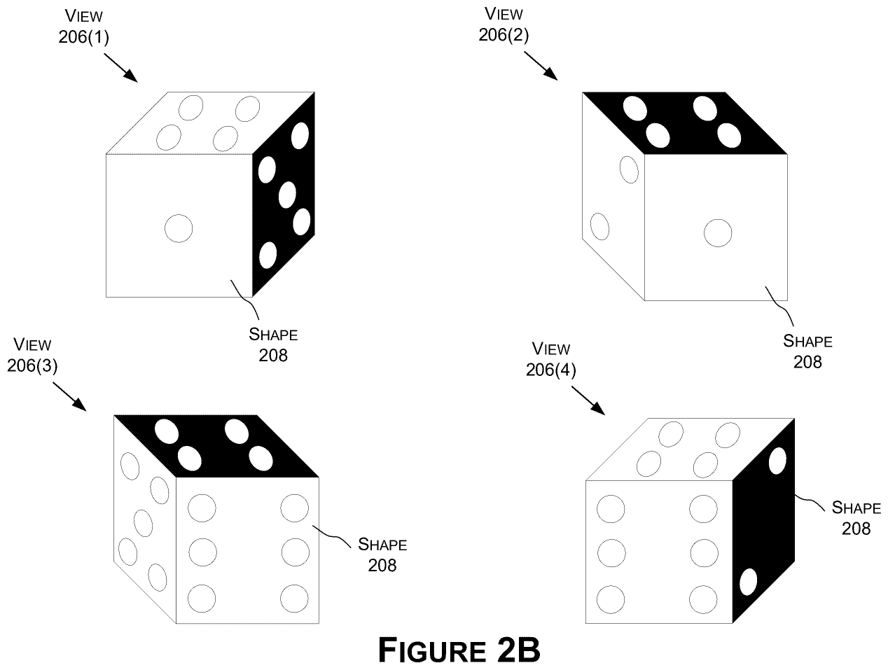

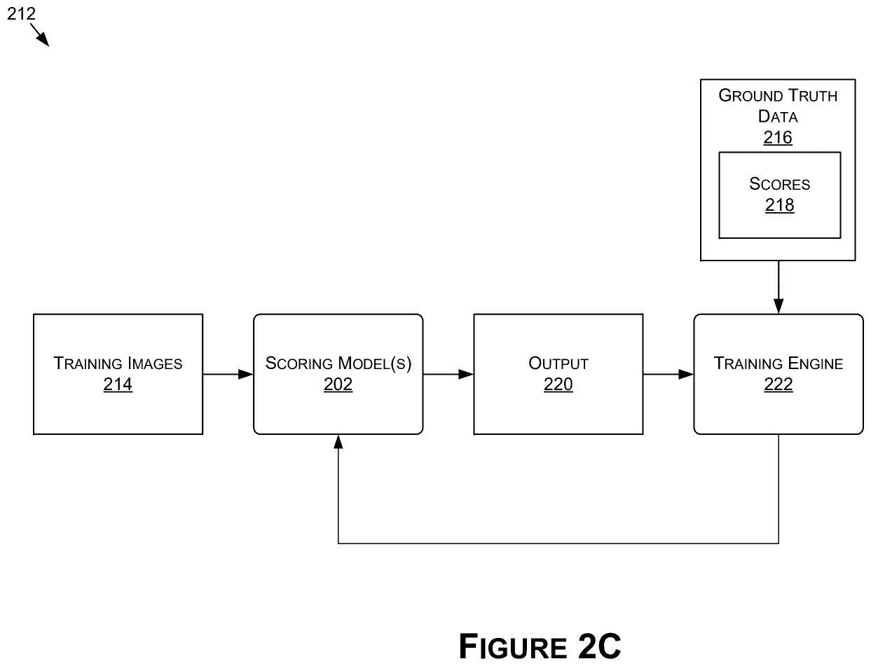

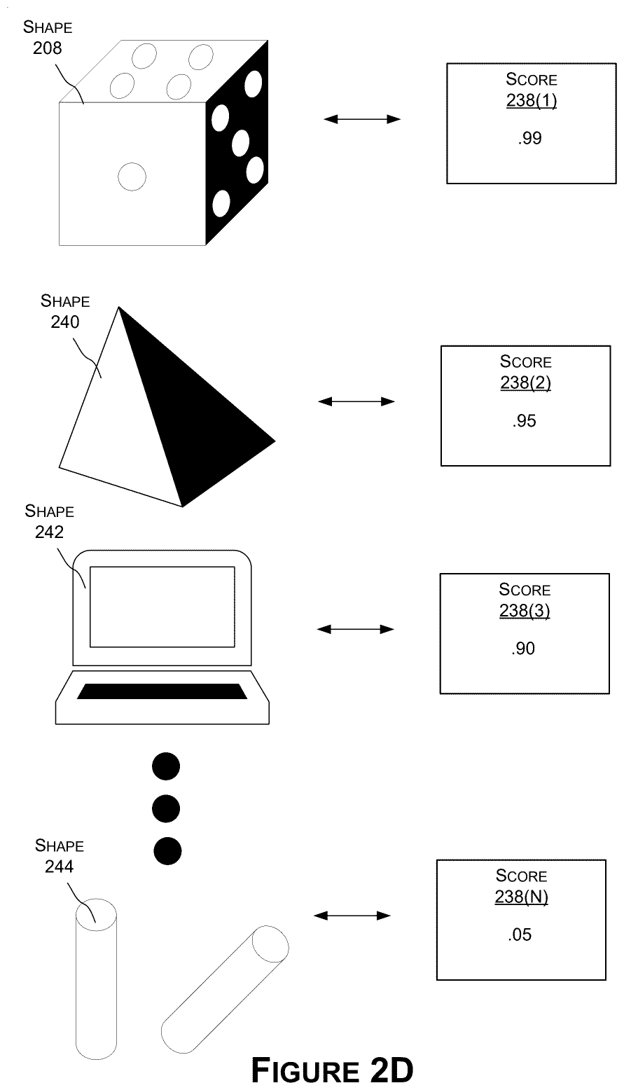

For more details about the filtering pipeline 108, FIG. 2A illustrates an example of the filtering pipeline 108 that filters shapes, in accordance with some embodiments of the present disclosure. As shown, the filtering pipeline 108 may include one or more processing elements that build a training set for training one or more scoring models 202, where the processing elements may be referred to as a “training element(s) 204.” As described herein, a training set may include training images that represent high-quality shapes, training images that represent low-quality shapes, and/or ground truth data that annotates the training images with quality scores of the shapes. For instance, the quality scores may be within a range, such as 0 to 1 (and/or any other range), where the quality scores increase with the increased quality of the shapes (e.g., the more accurate shapes include higher quality scores). For a first example, the ground truth data may represent the highest quality score for the high-quality shapes, such as 1, and the lowest quality score for the low-quality shapes, such as 0. For a second example, the ground truth data may represent quality scores that are within the range of 0 and 1, as determined by one or more users.

In some examples, the training set may be associated with a first threshold number of high-quality shape and/or a second threshold number of low-quality shapes, where a threshold number of shapes may include 50 shapes, 100 shapes, and/or any other number of shapes. Additionally, and similar to processing that is performed by the scoring model(s) 202, the training images may include multiple images representing multiple views for an individual shape, where each view is associated with a respective orientation of a camera with respect to the individual shape. For example, a shape may be rendered using four images, where each image is associated with a camera being placed on a top of a bounding shape (e.g., a bounding box) associated with the shape and oriented towards an origin of the shape.

For instance, FIG. 2B illustrates an example of rendering different views 206(1)-(4) of a shape 208, where the views 206(1)-(4) may be used to train the scoring model(s) 202 and/or score the shape 208, in accordance with some embodiments of the present disclosure. As shown, a first image may represent the first view 206(1) of the shape 208, a second image may represent the second view 206(2) of the shape 208, a third image may represent the third view 206(3) of the shape 208, and a fourth image may represent the fourth view 206(4) of the shape. While the example of FIG. 2B illustrates the views 206(1)-(4) as being associated with a camera capturing different corners of the shape 208, in other examples, views may be associated with any other orientation of the camera that is with respect to the shape 208. Additionally, while the example of FIG. 2B illustrates the shape 208 as including a die with physical indentations for the numbering (e.g., not just coloring), in other examples, any other type of shape may be used.

Referring back to the example of FIG. 2A, the training element(s) 204 may then use the training set to train the scoring model(s) 202, which may be represented by 210. For instance, FIG. 2C illustrates a data flow diagram illustrating a process 212 for training the scoring model(s) 202, in accordance with some embodiments of the present disclosure. As shown, the scoring model(s) 202 may be trained using both training images 214 from the training set along with corresponding ground truth data 216 from the training set, where the ground truth data 216 represents at least quality scores 218 associated with the training images 214. As described herein, the ground truth data 216 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the quality scores 218 of the labels), and/or a combination thereof. In some examples, for each training image 214, there may be corresponding ground truth data 216.

The scoring model(s) 202 may process data associated with the training images 214, such as embeddings representing the training images 214 as described in more detail herein, and generate outputs 220 indicating quality scores for the shapes. A training engine 222 may then use one or more loss functions that measure losses (e.g., errors) in the outputs 220 as compared to the ground truth data 216. Additionally, in some examples, backward pass computations may be performed to recursively compute gradients of the loss function(s) with respect to training parameters. In some examples, weights and biases of the scoring model(s) 202 may be used to compute these gradients. The training engine 222 may then use these gradients to update one or more parameters and/or weights associated with the scoring model(s) 202, which is indicated by the arrow from the training engine 222 to the scoring model(s) 202.

Referring back to the example of FIG. 2A, either while training and/or after training the scoring model(s) 202 using the training set, the filtering pipeline 108 may include one or more processing elements for rendering images and/or extracting features (e.g., CLIP features) associated with the images, which may be referred to as a “rendering element(s) 224.”. For instance, the rendering element(s) 224 may render one or more images depicting a shape, where each image may depict a respective view of the shape with respect to a camera position (e.g., similar to the example of FIG. 2B). For example, the shape may be rendered using four images, where each image is associated with a camera being (e.g., virtually) placed directly above a bounding shape (e.g., a bounding box) associated with the shape and oriented towards an origin of the shape.

The rendering element(s) 224 may then generate one or more embeddings 226 associated with the image(s). For a first example, the rendering element(s) 224 may generate an individual embedding 226 for each image depicting the shape. For a second example, the rendering element(s) 224 may generate a single embedding 226 for the image(s) depicting the shape, such as by averaging the embedding(s) 226 of the image(s). In either example, the rendering element(s) 224 may use any technique to generate the embedding(s) 226, such as one or more machine learning models, one or more neural networks, one or more transformers, one or more encoders, and/or the like. Additionally, the rendering element(s) 224 may use similar processes to generate embeddings 226 associated with any number of the shapes represented by the converted 3D data 106.

The filtering pipeline 108 may then include the scoring model(s) 202 processing the embeddings 226 and, based at least on the processing, generating and/or outputting data representing quality scores 228 associated with the shapes. The filtering pipeline 108 may then include one or more processing elements for evaluating the scoring model(s) 202, which may be referred to as an “evaluation element(s) 230.” In some examples, the evaluation may include determining whether the scoring model(s) 202 generated a respective quality score 228 for one or more (e.g., each) of the shapes and/or images. In some examples, the evaluation may include determining whether the scoring model(s) 202 generated accurate quality scores 228 associated with the shapes. For instance, one or more users may review at least a portion of the quality scores 228 to determine accuracies associated with the quality scores 228 and/or the scoring model(s) 202.

The filtering pipeline 108 may then include one or more processing elements for ranking and evaluating the shapes based at least on the quality scores 228, which may be referred to as a “ranking element(s) 232.” For instance, the ranking element(s) 232 may generate the rankings starting with the shape associated with the highest quality score 228, followed by the shape associated with the second highest quality score 228, followed by the shape associated with the third highest quality score 228, and/or so forth until the shape associated with the lowest quality score 228. The ranking element(s) 232 may then include using the rankings and/or the quality scores 228 to select shapes to include in an initial subset of shapes, where the initial subset of shapes is represented by initial filtered 3D data 234. As described herein, the ranking element(s) 232 may use one or more techniques to select the shapes to include in the initial subset of shapes.

For instance, the ranking element(s) 232 may select shapes that are associated with quality scores 228 that satisfy (e.g., are equal to or greater than) a threshold score 236. In some examples, the ranking element(s) 232 may use a predetermined threshold score 236 to perform the filtering, such as 0.7, 0.8, 0.9, 0.95, and/or any other score that falls within the range of quality scores. Additionally, or alternatively, in some examples, the ranking element(s) 232 may dynamically determine the threshold score 236, such as by using the quality scores 228 associated with the shapes. For example, the ranking element(s) 232 may determine a distribution associated with the quality scores 228, such as a histogram (and/or any other type of distribution), and then use the distribution to determine the threshold score. This way, the ranking element(s) 232 may ensure that the initial subset of shapes includes at least a threshold number of the highest quality shapes.

For instance, FIG. 2D illustrates an example of ranking an initial set of shapes and then filtering the initial set of shapes based at least on the rankings, in accordance with some embodiments of the present disclosure. As shown, the shape 208 may be ranked first with a quality score 238(1) of 0.99, a shape 240 may be ranked second with a quality score 238(2) of 0.95, a shape 242 may be ranked third with a quality score 238(3) of 0.90, and this may continue until a shape 244 is ranked last with a quality score 238(N) of 0.05. As such, and using the rankings, if a threshold score includes 0.80 in the example of FIG. 2D, the shapes 208, 240, and 242 may be selected from the set of shapes based at least on the quality scores 238(1)-(3) satisfying the threshold score. Additionally, the shape 244 may be removed from the set of shapes based at least on the quality score 238(N) not satisfying the threshold score.

Referring back to the example of FIG. 2A, the filtering pipeline 108 may include one or more processing elements that perform active learning by selecting shapes (and the images that depict the selected shapes) for further training the scoring model(s) 202, which may be referred to as a “learning element(s) 246.” As described herein, the learning element(s) 246 may select the shapes for further training based at least on the rankings associated with the shapes and/or the quality scores 228 associated with the shapes. For example, the learning element(s) 246 may select shapes that are associated with incorrect quality scores 228 (e.g., a low-quality shape that was ranked high, a medium-quality shape that was ranked low or high, a high-quality shape that was ranked low, etc.), select high-quality shapes, select low-quality shapes, and/or use any other technique to select the shapes. In some examples, the learning element(s) 246 may automatically select the shapes, such as by analyzing the rankings and/or the quality scores 228. Additionally, or alternatively, in some examples, the learning element(s) 246 may select the shapes based at least on user feedback, such as user feedback indicating incorrect quality scores for shapes.

The learning element(s) 246 may then further train the scoring model(s) 202 using the selected shapes, which may be represented by 248. For example, if it was determined that the original quality scores 228 associated with the (images depicting the) selected shapes were incorrect, then the learning element(s) 246 may determine updated quality scores 228 associated with the images depicting the selected shapes (e.g., using user feedback). The learning element(s) 246 may then generate new training images associated with the selected shapes, using one or more of the processes described herein, and add the new training images along with the updated quality scores 228 to the training set. Additionally, the learning element(s) 246 may use at least the new training images and/or the updated quality scores 228 to further train the scoring model(s) 202, such as by using the process 212 from the example of FIG. 2C. In some examples, the filtering pipeline 108 may then continue to perform these processes of training the scoring model(s) 202 until the occurrence of one or more events. For example, the filtering pipeline 108 may continue performing these processes for a threshold number of iterations, until the scoring model(s) 202 satisfies an accuracy threshold, and/or until any other event occurs.

In some examples, and as illustrated by the example of FIG. 2A, the filtering pipeline 108 may include one or more processing elements that further filter the initial subset of shapes, which may be referred to as a “filtering element(s) 250.” As described herein, to further filter the shapes, the filtering element(s) 250 may use one or more rules 252 for removing shapes. In some examples, the rule(s) 252 may include, but is not limited to, a rule 252 to remove corrupted shapes, a rule 252 to remove shapes that are associated with large scenes, a rule 252 to remove shapes that are associated with scenes that include one or more additional shapes, a rule 252 to remove shapes that represent ground planes, a rule 252 to remove shapes that represent backdrops, and/or any other rule. Based at least on the further filtering, the filtering pipeline 108 may then generate and/or output the filtered 3D data 110 representing a final subset of shapes.

For example, and referring back to the example of FIG. 2D, after performing the initial filtering of the set of shapes 208, 240, 242, and 244 using the quality scores 238(1)-(N), the shapes 208, 240, and 242 may be selected for inclusion in an initial subset of shapes. Next, the filtering element(s) 250 may perform one or more of the processes described herein to further filter the initial subset of shapes, such as by using the rule(s) 252. For example, if a rule 252 indicates removing shapes that are associated with scenes that include additional shapes, the filtering element(s) 250 may process data associated with the shapes 208, 240, and 242 and determine, based at least on the processing, that the shapes 244 are associated with a scene that includes at least one other shape. As such, the filtering element(s) 250 may remove the shape 242 from the initial subset of shapes in order to generate a final subset of shapes that includes the shapes 208 and 240.

Referring back to the example of FIG. 1, the process 100 may include using a 3D-alignment pipeline 112 to process the filtered 3D data 110 and, based at least on the processing, determine poses associated with views of the shapes (e.g., the subset of shapes). As described herein, for a shape, a pose may include multiple gravity orientations (e.g., six gravity orientations, etc.), where each gravity orientation is associated with a respective coordinate direction (e.g., a positive x-direction, a negative x-direction, a positive y-direction, a negative y-direction, a positive z-direction, and a negative z-direction), and multiple azimuth angles (e.g., eight azimuth angle, etc.), wherein each azimuth angle is associated with a respective angle (e.g., 15 degrees, 30 degrees, 45 degrees, 60 degrees, 75 degrees, 90 degrees, etc.). Additionally, in some examples, the 3D-alignment pipeline 112 may further be configured to align the shapes with respect to one another using the determined poses, such as by using a common reference pose (e.g., a canonical pose). The output from the 3D-alignment pipeline 112 may then include 3D-pose data 114 representing the poses associated with the views of the shapes and/or information for aligning the shapes based at least on the poses.

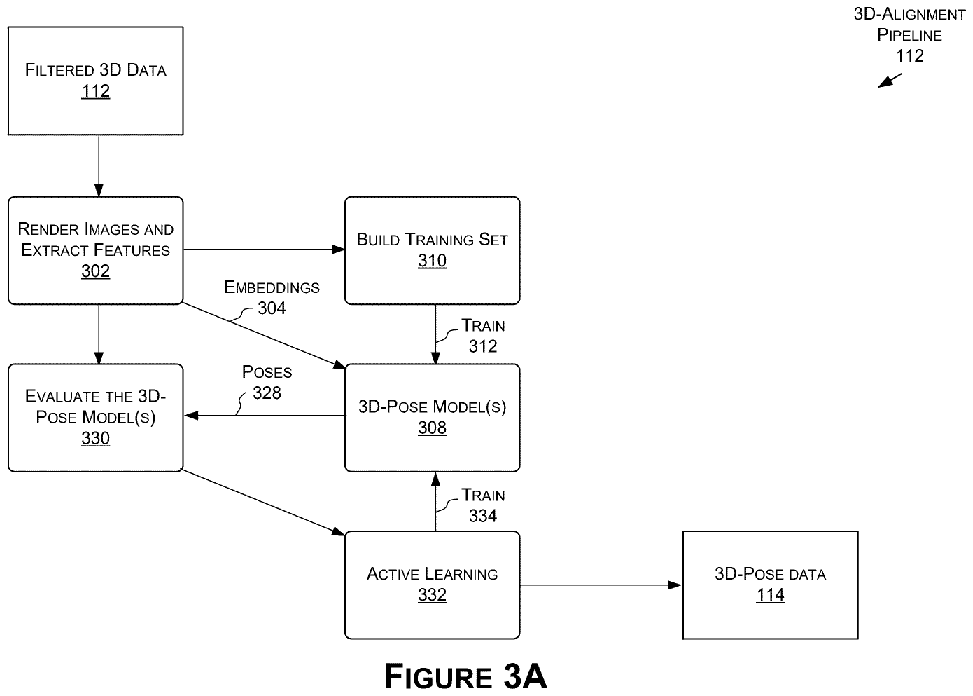

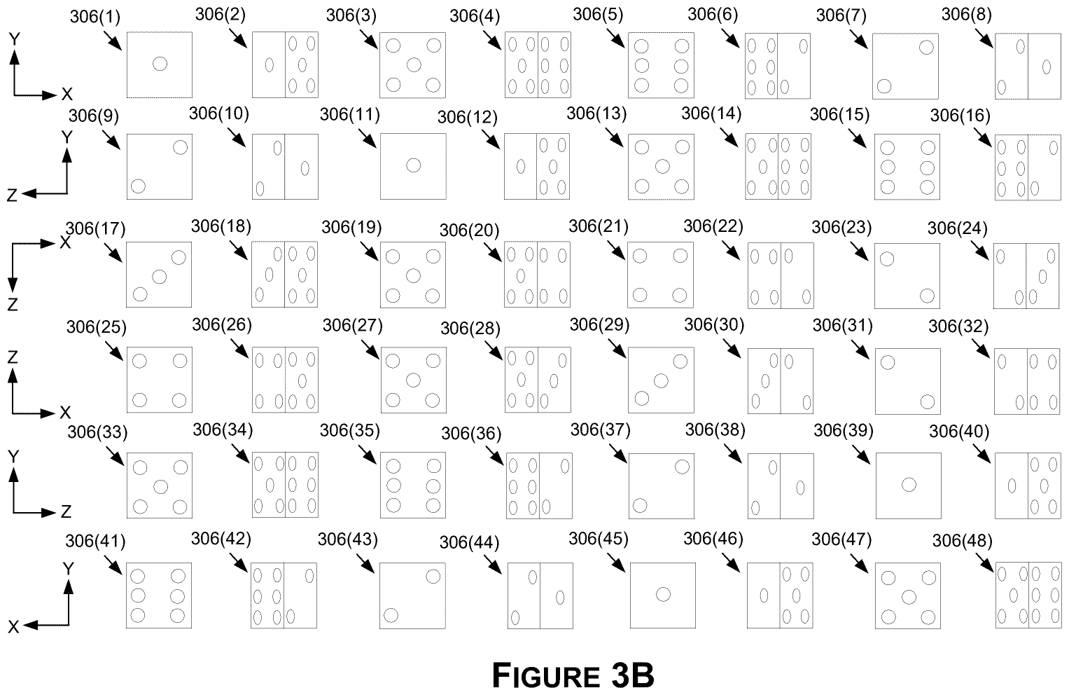

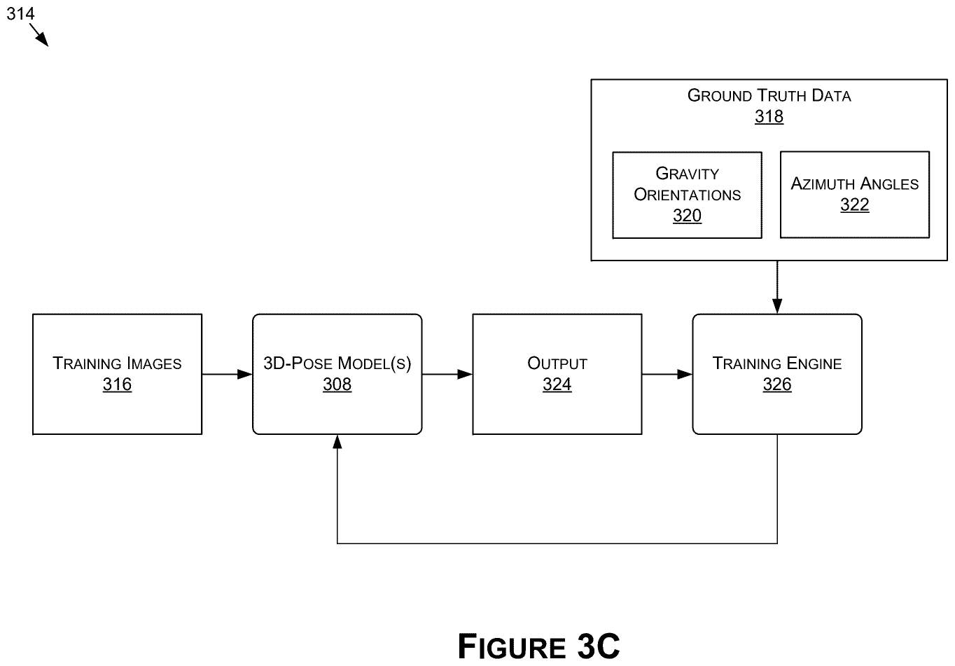

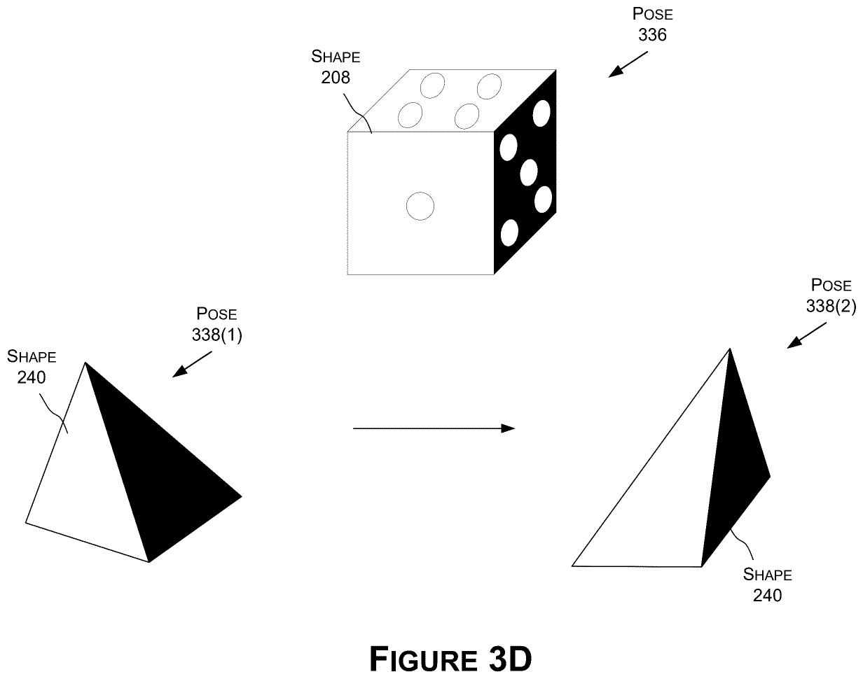

For more details about the 3D-alignment pipeline 112, FIG. 3A illustrates an example of the 3D-alignment pipeline 112 that aligns shapes, in accordance with some embodiments of the present disclosure. As shown, the 3D-alignment pipeline 112 may include one or more processing elements for rendering images and/or extracting features (e.g., CLIP features) associated with the images, which may be referred to as a “rendering element(s) 302.” For instance, the rendering element(s) 302 may render one or more images representing a shape, where each image may represent a respective pose view of the shape. For example, the shape may be rendered using forty-eight images (and/or any other number of images), where each image is associated with one of the six gravity orientations as well as one of the eight azimuth angles. However, in other examples, the shape may be rendered using any number of images, any number of gravity orientations, and/or any number of azimuth angles.

For instance, FIG. 3B illustrates an example of rendering the shape 208 using different views 306(1)-(48) (also referred to singularly as “view 306” or in plural as “views 306”), in accordance with some embodiments of the present disclosure. As shown, the views 306(1)-(8) may be associated with a first gravity orientation, the views 306(9)-(16) may be associated with a second gravity orientation, the views 306(17)-(24) may be associated with a third gravity orientation, the views 306(25)-(32) may be associated with a fourth gravity orientation, the views 306(33)-(40) may be associated with a fifth gravity orientation, and the views 306(41)-(48) may be associated with a sixth gravity orientation, where the gravity orientations may be indicated by the coordinate systems. Additionally, for a respective gravity orientation, such as the first gravity orientation, the views 306(1)-(8) may be associated with different azimuth angle, such as azimuth angles that are incremented by 45 degrees. While the example of FIG. 3B illustrates using six gravity orientations and eight azimuth angles, in other examples, any number of gravity orientations and/or any number of azimuth angles may be used.

Referring back to the example of FIG. 3A, the rendering element(s) 302 may then generate embeddings 304 associated with the images. For a first example, the rendering element(s) 302 may generate an individual embedding 304 for each image representing the shapes. For a second example, the rendering element(s) 302 may generate a single embedding 304 for more than one image representing a shape, such as by averaging the embedding(s) 304 for the image(s). In either example, the rendering element(s) 302 may use any technique to generate the embedding(s) 304, such as one or more machine learning models, one or more neural networks, one or more transformers, one or more encoders, and/or the like.

The 3D-alignment pipeline 112 may further include one or more processing elements that are configured to build a training set for training one or more 3D-pose models 308, which may be referred to as a “training element(s) 310.” As described herein, the training set may include images depicting a number of shapes, such as 100 shapes, 500 shapes, 1,000 shapes, 6,000 shapes, 10,000 shapes, and/or any other number of shapes. Additionally, for the shapes, the training set may include the images of the views generated using the rendering element(s) 302, where these images may be referred to as training images, along with ground truth data representing the poses associated with the training images. For instance, the training set may include training images of the different views of a (e.g., each) shape along with ground truth data representing a respective gravity orientation and a respective azimuth angle associated with each image that depicts the shape. The training element(s) 310 may then be configured to use the training set to train the 3D-pose model(s) 308, which is represented by 312.

For instance, FIG. 3C illustrates a data flow diagram illustrating a process 314 for training the 3D-pose model(s) 308, in accordance with some embodiments of the present disclosure. As shown, the 3D-pose model(s) 308 may be trained using both training images 316 from the training set along with corresponding ground truth data 318 from the training set, where the ground truth data 318 represents at least gravity orientations 320 and azimuth angles 322 associated with the training images 316. As described herein, the ground truth data 318 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the gravity orientations 320 and/or the azimuth angles 322), and/or a combination thereof. In some examples, for each training image 316, there may be corresponding ground truth data 318.

The 3D-pose model(s) 308 may process data associated with the training images 316, such as embeddings representing the training images 316 as described in more detail herein, and generate outputs 324 indicating poses (e.g., gravity orientations, azimuth angles, etc.) for the images of the shapes. A training engine 326 may then use one or more loss functions that measure losses (e.g., errors) in the outputs 324 as compared to the ground truth data 318. Additionally, in some examples, backward pass computations may be performed to recursively compute gradients of the loss function(s) with respect to training parameters. In some examples, weights and biases of the 3D-pose model(s) 308 may be used to compute these gradients. The training engine 326 may then use these gradients to update one or more parameters and/or weights associated with the 3D-pose model(s) 308, which is indicated by the arrow from the training engine 326 to the 3D-pose model(s) 308.

Referring back to the example of FIG. 3A, the 3D-alignment pipeline 112 may then include the 3D-pose model(s) 308 processing the embeddings 304 and, based at least on the processing, generating and/or outputting data representing poses 328 associated with the views of the shapes. As describes herein, for a shape, a pose 328 may be associated with a gravity orientation and an azimuth angle. The 3D-alignment pipeline 112 may then include one or more processing elements that evaluate the 3D-pose model(s) 308, which may be referred to as an “evaluation element(s) 330.” In some examples, the evaluation may include determining whether the 3D-pose model(s) 308 generated a respective pose 328 for one or more (e.g., each) of the views of the shapes. Additionally, or alternatively, in some examples, the evaluation may include determining whether the 3D-pose model(s) 308 generated accurate poses 328 associated with the views of the shapes. For instance, one or more users may review at least a portion of the poses 328 in order to determine an accuracy associated with the poses 328 and/or the 3D-pose model(s) 308.

The 3D-alignment pipeline 112 may further include one or more processing elements that perform active training to further train the 3D-pose model(s) 308, which may be referred to as a “learning element(s) 332.” In some examples, to further train the 3D-pose model(s) 308, the learning element(s) 332 may select an additional number of shapes that were processed using the 3D-pose model(s) 308 and/or an additional number of images of views of the shapes that were processed using the 3D-pose model(s) 308. As described herein, an additional number of shapes may include, but is not limited to, 50 shapes, 100 shapes, 500 shapes, 1,000 shapes, and/or any other number of shapes. Additionally, an additional number of images may include, but is not limited to, 100 images, 500 images, 1,000 images, and/or any other number of images. In some examples, the learning element(s) 332 may automatically select the shapes and/or images, such as by analyzing the poses 328 (e.g., selecting shapes and/or images for which the poses 328 were incorrect). Additionally, or alternatively, in some examples, the learning element(s) 332 may select the shapes and/or images based at least on user feedback, such as user feedback indicating that poses associated with shapes and/or images were incorrect.

The learning element(s) 332 may then further train the 3D-pose model(s) 308 using the selected shapes and/or images, which may be represented by 334. For example, if it was determined that the original poses 328 associated with the selected shapes and/or images were incorrect, then the learning element(s) 332 may determine updated poses 328 associated with the selected shapes and/or images (e.g., using user feedback). The learning element(s) 332 may then generate new training images associated with the selected shapes, using one or more of the processes described herein, and add the new training images along with the updated poses 328 to the training set. Additionally, the learning element(s) 332 may use at least the new training images and/or the updated poses 328 to further train the 3D-pose model(s) 308, such as by using the process 314 from the example of FIG. 3C. In some examples, the 3D-alignment pipeline 112 may then continue to perform these processes of training the 3D-pose model(s) 308 until the occurrence of one or more events. For example, the 3D-alignment pipeline 112 may continue performing these processes for a threshold number of iterations, until the 3D-pose model(s) 308 satisfies an accuracy threshold, and/or until any other event occurs.

As further illustrated by the example of FIG. 3A, the output from the 3D-alignment pipeline 112 may include at least the 3D-pose data 114 that represents the poses 328 associated with the views of the shapes. Additionally, in some examples, the 3D-pose data 114 may represent information for aligning the shapes with respect to one another, such as by using a common reference pose (e.g., a canonical pose).

For instance, FIG. 3D illustrates an example of using pose information to align shapes with respect to one another, in accordance with some embodiments of the present disclosure. As shown, the shape 208 may be initially oriented in a pose 336 while the shape 240 is initially oriented in a first pose 338(1). Using the poses determined by the 3D pose model(s) 308, the 3D-alignment pipeline 112 may then orient the shape 240 in a second pose 338(1) that is similar to the pose 336 of the shape 208. For instance, in some examples, the pose 336 of the shape 208 and the second pose 338(2) of the shape 240 may be associated with a canonical pose for shapes.

Referring back to the example of FIG. 1, the process 100 may include using a 2D-alignment pipeline 116 to process 2D data 118 representing a set of shapes. As described herein, in some examples, the 2D data 118 may represent images of the shapes that were already rendered, such as by one or more applications, programs, application programming interfaces (APIs), or application plug-ins, implemented using one or more computing devices, systems, and/or any the like. Additionally, and for a (e.g., each) shape, the 2D data 118 may represent the shape using multiple images, where each image represents a respective view of the shape. As described herein, in some examples, a respective view of a shape may be associated with an elevation relative to the shape (e.g., an elevation of a camera that captured the shape) and/or an azimuth angle relative to the shape (e.g., an angle of the camera that captured the shape). For example, the 2D data 118 for a shape may represent at least one or more first images representing the shape at one or more first views associated with a first elevation and one or more first azimuth angles, one or more second images representing the shape at one or more second views associated with a second elevation and one or more second azimuth angles, one or more third images representing the shape at one or more third views associated with a third elevation and one more third azimuth angles, and/or so forth.

Based at least on processing the 2D data 118, the 2D-alignment pipeline 116 may be configured to determine poses associated with the images of the shapes, align the shapes with respect to a common reference pose (e.g., a canonical pose), and/or filter out at least a portion of the shapes to generate a final subset of shapes. As described herein, in some examples, a pose associated with an image of a shape may indicate at least an azimuth angle of the shape as represented by the image. Additionally, the 2D-alignment pipeline 116 may filter the shapes using one or more rules, such as a rule to remove shapes that includes a wrong gravity orientation, a rule to remove shapes that are associated with a similar identifier and multiple articulations, a rule to remove shapes with embeddings that include high similarities to embeddings of other shapes (e.g., neighboring shapes), and/or using any other rule. In any of these examples, the output from the 2D-alignment pipeline 116 may include 2D-pose data 120 representing the poses associated with the images of the shapes (e.g., the subset of the shapes after filtering) and/or information for aligning the shapes.

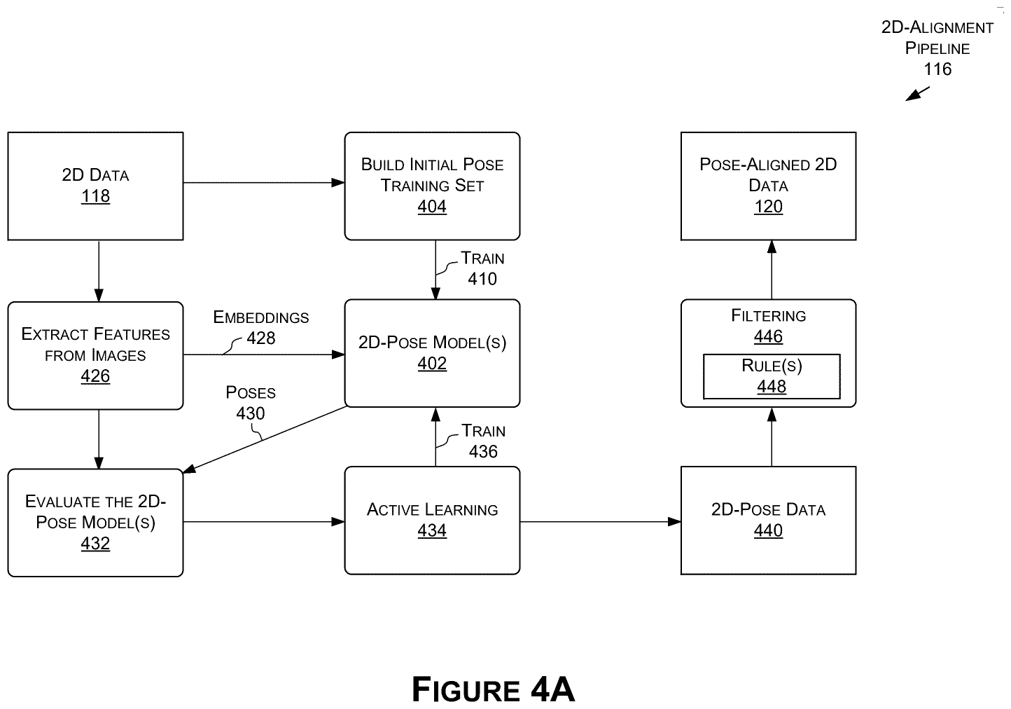

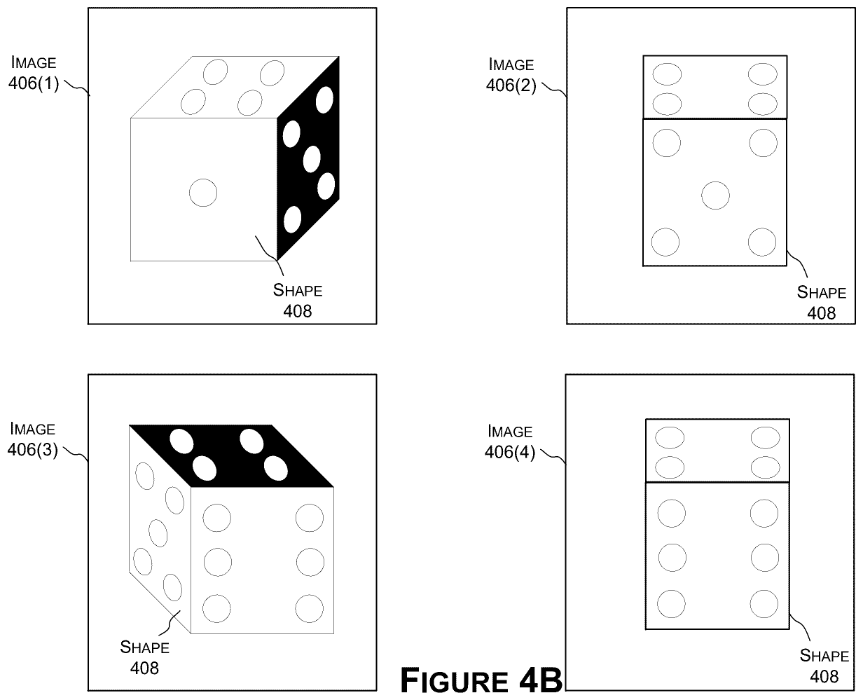

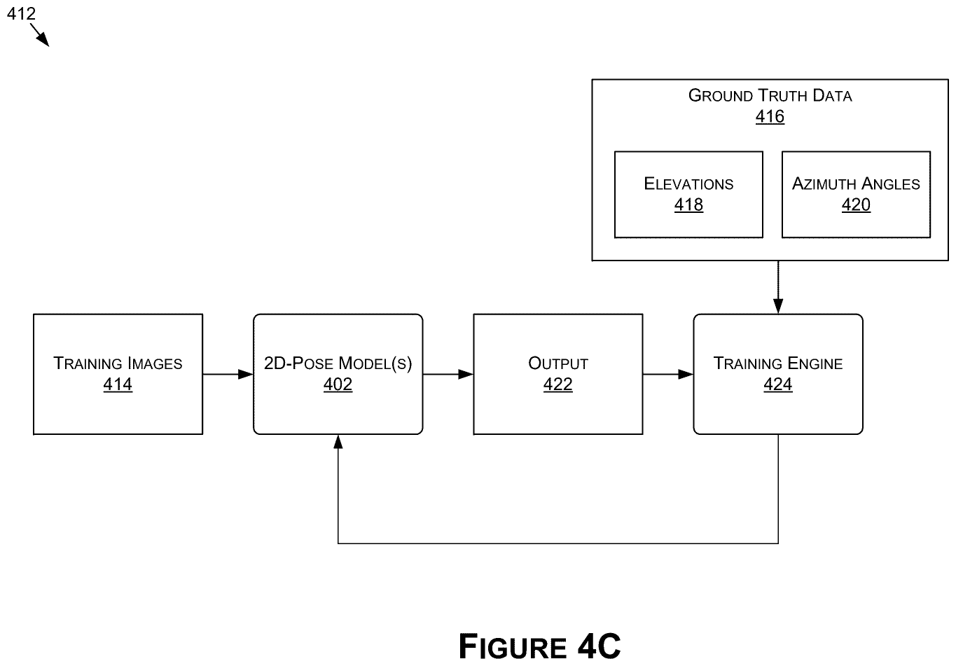

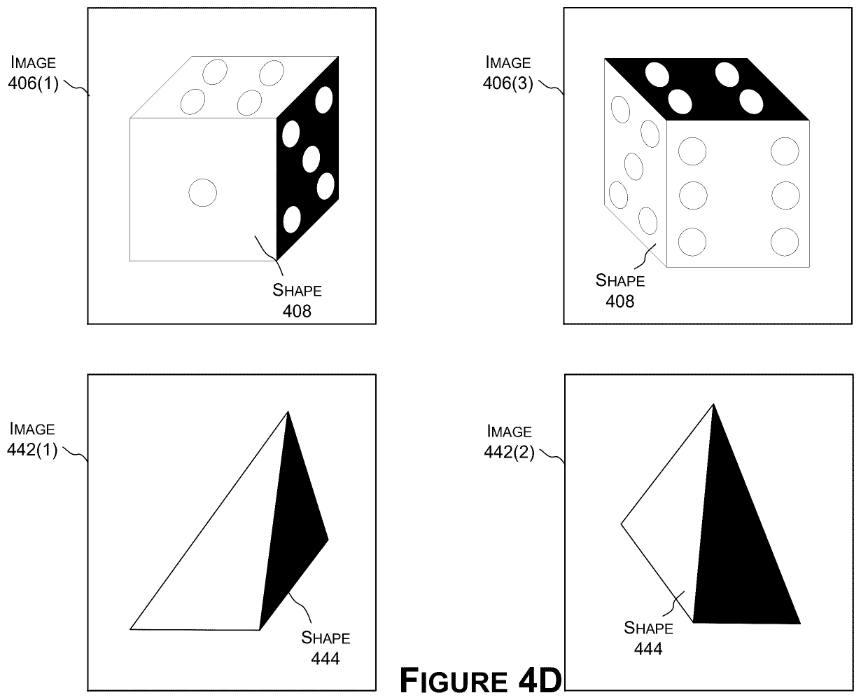

For more details about the 2D-alignment pipeline 116, FIG. 4A illustrates an example of the 2D-alignment pipeline 116 that aligns shapes, in accordance with some embodiments of the present disclosure. As shown, the 2D-alignment pipeline 116 may include one or more processing elements that are configured to build a training set for training one or more 2D-pose models 402, which may be referred to as a “training element(s) 404.” As described herein, a training set may include training images representing one or more views of the shapes, such as views that are associated with one or more elevations and/or one or more azimuth angles. For example, and for a shape, the training set may include four images representing the shape at a similar elevation (e.g., 30 degrees, 45 degrees, 60 degrees, etc.), but with four different azimuth angles. The training set may further include ground truth data associated with the training images, where the ground truth data represents the elevations and/or the azimuth angles associated with the training images.

For instance, FIG. 4B illustrates an example of rendering images 406(1)-(4) of a shape 408, where the images 406(1)-(4) are associated with different azimuth angles, in accordance with some embodiments of the present disclosure. As shown, the first image 406(1) may represent a first view of the shape 408, the second image 406(2) may represent a second view of the shape 408, the third image 406(3) may represent a third view of the shape 408, and the fourth image 406(4) may represent a fourth view of the shape 408. Additionally, the images 406(1)-(4) may represent the shape 408 using a similar elevation, but with different azimuth angles. While the example of FIG. 4B illustrates four images 406(1)-(4) representing the shape 408 at four different views, in other examples, any number of images may be used to represent the shape at any number of views. Additionally, while the example of FIG. 4B illustrates the shape 408 as including a die with physical indentations for the numbering (e.g., not just coloring), in other examples, any other type of shape may be used.

Referring back to the example of FIG. 4A, the training element(s) 404 may then use the training set to train the 2D-pose model(s) 402, which may be represented by 410. For instance, FIG. 4C illustrates a data flow diagram illustrating a process 412 for training the 2D-pose model(s) 402, in accordance with some embodiments of the present disclosure. As shown, the 2D-pose model(s) 402 may be trained using both training images 414 from the training set along with corresponding ground truth data 416 from the training set, where the ground truth data 416 represents at least elevation orientations 418 and azimuth angles 420 associated with the training images 414. As described herein, the ground truth data 416 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the elevation orientations 418 and/or the azimuth angles 420), and/or a combination thereof. In some examples, for each training image 414, there may be corresponding ground truth data 416.

The 2D-pose model(s) 402 may process data associated with the training images 414, such as embeddings representing the training images 414 as described in more detail herein, and generate outputs 422 indicating poses (e.g., elevations, azimuth angles, etc.) for the training images 414. A training engine 424 may then use one or more loss functions that measure losses (e.g., errors) in the outputs 422 as compared to the ground truth data 416. Additionally, in some examples, backward pass computations may be performed to recursively compute gradients of the loss function(s) with respect to training parameters. In some examples, weights and biases of the 2D-pose model(s) 402 may be used to compute these gradients. The training engine 424 may then use these gradients to update one or more parameters and/or weights associated with the 2D-pose model(s) 402, which is indicated by the arrow from the training engine 424 to the 2D-pose model(s) 402.

Referring back to the example of FIG. 4A, the 2D-alignment pipeline 116 may include one or more processing elements that are configured to extract features associated with the images of the shapes as represented by the 2D data 118, which may be referred to as a “processing element(s) 426.” In some examples, and for a shape, the processing element(s) 426 may initially select one or more images that represent one or more views of the shape. For example, the processing element(s) 426 may select four images representing four views of the shape, where each image is associated with a similar elevation and a respective azimuth angle, similar to the example of FIG. 4B. However, in other examples, the processing element(s) 426 may select any number of images representing any number of views of the shape using any number of elevations and/or any number of azimuth angles.

The processing element(s) 426 may then extract features (e.g., CLIP features, etc.) from the images, such as by generating one or more embeddings 428 associated with the images of the shapes. For a first example, the processing element(s) 426 may generate an individual embedding 428 for each image representing the shapes. For a second example, the processing element(s) 426 may generate a single embedding 428 for more than one image representing a shape, such as by averaging the embeddings 428 for the images. In either example, the processing element(s) 426 may use any technique to generate the embedding(s) 428, such as one or more machine learning models, one or more neural networks, one or more transformers, one or more encoders, and/or the like.

The 2D-alignment pipeline 116 may then include the 2D-pose model(s) 402 processing the embeddings 428 and, based at least on the processing, generating and/or outputting data representing poses 430 associated with the images of the shapes. As described herein, since the poses 430 are associated with the 2D data 118, the poses 430 may include elevations and/or azimuth angles associated with the images. The 2D-alignment pipeline 116 may then include one or more processing elements that are configured to evaluate the 2D-pose model(s) 402, which may be referred to as an “evaluation element(s) 432.” In some examples, the evaluation may include determining whether the 2D-pose model(s) 402 generated a respective pose 430 for one or more (e.g., each) of the images. Additionally, or alternatively, in some examples, the evaluation may include determining whether the 2D-pose model(s) 402 generated accurate poses 430 associated with the images. For instance, one or more users may review at least a portion of the poses 430 in order to determine an accuracy associated with the poses 430 and/or the 2D-pose model(s) 402.

The 2D-alignment pipeline 116 may further include one or more processing elements for performing active training in order to further train the 2D-pose model(s) 402, which may be referred to as a “learning element(s) 434.” In some examples, to perform the further training, the learning element(s) 434 may select an additional number of shapes that were processed using the 2D-pose model(s) 402 and/or an additional number of images that were processed using the 2D-pose model(s) 402. As described herein, an additional number of shapes may include, but is not limited to, 50 shapes, 100 shapes, 500 shapes, 1,000 shapes, and/or any other number of shapes. Additionally, an additional number of images may include, but is not limited to, 100 images, 500 images, 1,000 images, and/or any other number of images. In some examples, the learning element(s) 434 may automatically select the shapes and/or images, such as by analyzing the poses 430 (e.g., selecting shapes and/or images for which the poses 430 were incorrect). Additionally, or alternatively, in some examples, the learning element(s) 434 may select the shapes and/or images based at least on user feedback, such as user feedback indicating that poses associated with shapes and/or images are incorrect.

The learning element(s) 434 may then further train the 2D-pose model(s) 402 using the selected shapes and/or images, which may be represented by 436. For example, if it was determined that the original poses 430 associated with the selected shapes and/or images were incorrect, then the learning element(s) 434 may determine updated poses 430 associated with the selected shapes and/or images (e.g., using user feedback). The learning element(s) 434 may then add the selected images of the shapes along with the updated poses 430 associated with the selected images to the training set. Additionally, the learning element(s) 434 may use at least the new training images and/or the updated poses 430 to further train the 2D-pose model(s) 402, such as by using the process 412 from the example of FIG. 4C. In some examples, the 2D-alignment pipeline 116 may then continue to perform these processes of training the 2D-pose model(s) 402 until the occurrence of one or more events. For example, the 2D-alignment pipeline 116 may continue performing these processes for a threshold number of iterations, until the 2D-pose model(s) 402 satisfies an accuracy threshold, and/or until any other event occurs.

The 2D-alignment pipeline 116 may then generate initial 2D-pose data 440 that represents at least the poses 430 associated with the images representing the shapes and/or information for aligning the images using a common reference pose (e.g., a canonical pose). For example, if the shapes are represented using multiple images, where each image is associated with a respective pose (e.g., a set elevation, but with a respective azimuth angle), then the initial 2D-pose data 440 may represent information indicating which images represent the shapes using the common reference pose. In other words, the 2D-alignment pipeline 116 may perform these processes to automatically align the images of the shapes with respect to one another.

FIG. 4D illustrates an example of using poses to align shapes with respect to one another, in accordance with some embodiments of the present disclosure. As described herein, the 2D-alignment pipeline 116 may perform one or more of the processes described herein to determine a first pose associated with the first image 406(1) of the shape 408, a second pose associated with the third image 406(3) of the shape 408, a third pose associated with a first image 442(1) of a shape 444, and a fourth pose associated with a second image 442(2) of the shape 444. The 2D-alignment pipeline 116 may then use the poses to align the shapes 408 and 444. For instance, and as shown, the first image 406(1) and the first image 442(1) may respectively represent the shape 408 and the shape 444 in a similar pose. As such, an alignment may be created between the first image 406(1) and the first image 442(1). Additionally, the third image 406(3) and the second image 442(2) may respectively represent the shape 408 and the shape 444 in a similar pose. As such, an alignment may be created between the third image 406(3) and the second image 442(2). In some examples, these alignments may be represented by the 2D-pose data 440.

Referring back to the example of FIG. 4A, the 2D-alignment pipeline 116 may include using one or more processing elements, which may be referred to as a “filtering element(s) 446,” that are configured to filter the initial 2D-pose data 440 in order to generate the 2D-pose data 120 that is associated with a subset of shapes from the set of shapes. As described herein, in some examples, to perform the filtering, the filtering element(s) 446 may use one or more rules 252 to remove one or more shapes, such as a rule 252 to remove shapes that includes a wrong gravity orientation, a rule 252 to remove shapes that are associated with a similar identifier and multiple articulations, a rule 252 to remove shapes with embeddings that include high similarities to embeddings of other shapes (e.g., neighboring shapes), and/or using any other rule. In any of these examples, the output from the 2D-alignment pipeline 116 may include the 2D-pose data 120.

Referring back to the example of FIG. 1, the process 100 may include using an annotation pipeline 122 to generate annotations associated with shapes, such as the shapes associated with the 3D-pose data 114 and/or the shapes associated with the 2D-pose data 120. As described herein, the annotation pipeline 122 may use one or more language models to generate the annotations based at least on processing data associated with images representing the shapes, data representing descriptions associated with the shapes, data representing a format for outputs, and/or any other data. Additionally, the language model(s) may generate various types of annotations, such as short captions associated with the shapes and long captions associated with the shapes. As described herein, a short caption may include a first number of words that is less than a first threshold number of words and a long caption may include a second number of words that is equal to or greater than the first threshold number of words and/or less than a second threshold number of words. Additionally, a threshold number of words may include, but is not limited to, five words, ten words, twenty words, fifty words, one hundred words, and/or any other number of words.

In some examples, the annotation pipeline 122 may further be configured to generate embeddings for the captions. For example, the annotation pipeline 122 may include and/or use one or more machine learning models, one or more neural networks, one or more transformers, one or more encoders, and/or any other type of processing component to generate embeddings for the captions. In some examples, the annotation pipeline 122 may be configured to generate one or more embeddings for each shape and/or image. For a first example, such as when a shape is associated with both a short caption and a long caption, the annotation pipeline 124 may be configured to generate a first embedding associated with the short caption and a second embedding associated with the long caption. For a second example, and again when a shape is associated with both a short caption and a long caption, the annotation pipeline 124 may be configured to generate a single embedding associated with both the short caption and the long caption. The annotation pipeline 122 may then generate and/or output annotation data 124 representing the captions associated with the shapes and/or images and/or the embeddings associated with the shapes and/or images.

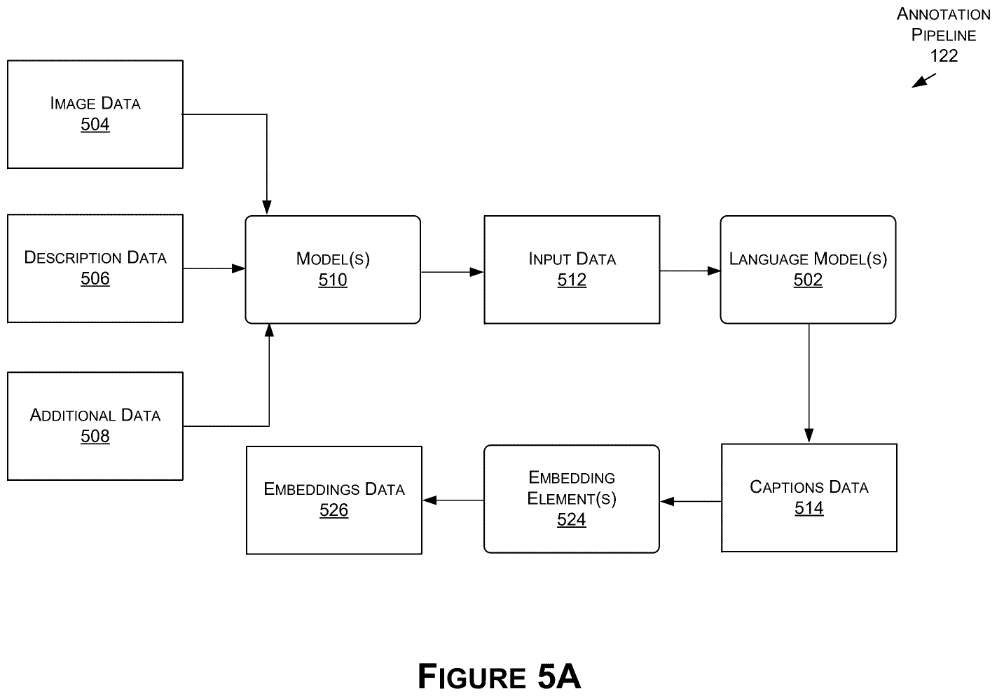

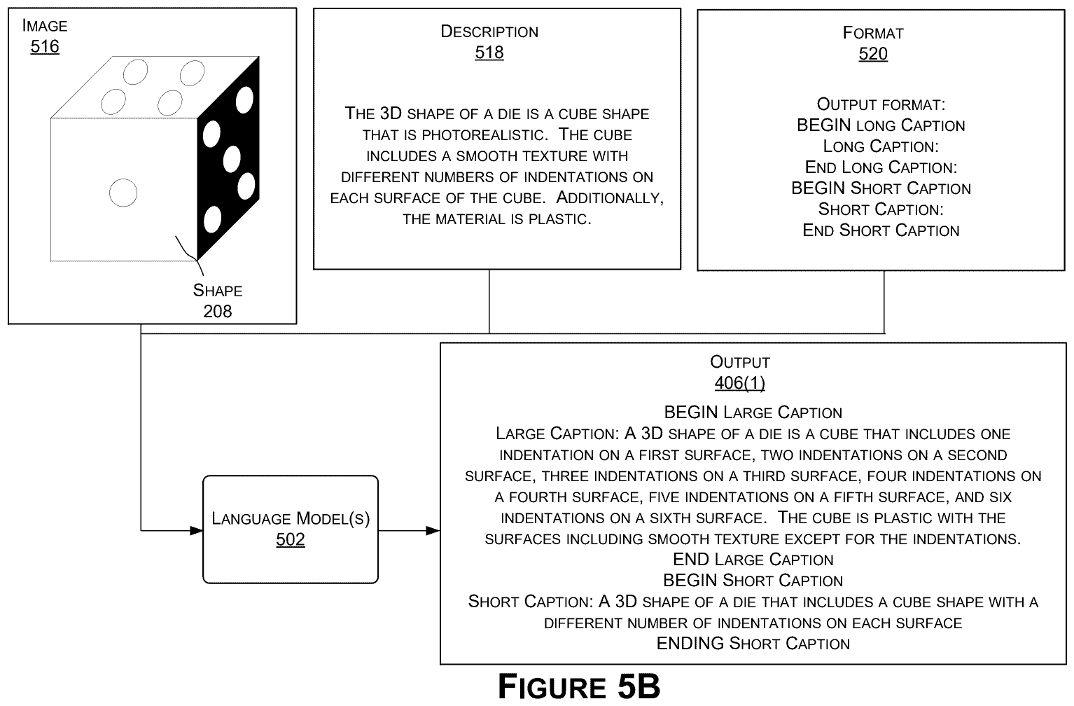

For more detail of the annotation pipeline 122, FIG. 5A illustrates an example of the annotation pipeline 122 that generates annotations associated with shapes, in accordance with some embodiments of the present disclosure. As shown, the annotation pipeline 122 may include one or more language models 502 receiving, as input, image data 504 representing images of shapes, description data 506 representing descriptions associated with the shapes, and/or additional data 508 representing additional text for inputting into the language model(s) 502. As described herein, the images represented by the image data 504 may represent the shapes using a common reference pose, such as a canonical pose. Additionally, the shapes may include one or more shapes associated with the 3D-pose data 114 and/or one or more shapes associated with the 2D-pose data 120.

Additionally, the descriptions may contain enough detail and/or information to reconstruct the shapes. For example, details and/or information associated with a shape may include text that describes the shape, such as an identifier (e.g., a name) of the shape, a category (e.g., type) of the shape, tags that represent characteristics (e.g., shape, size, color, texture, use, material, features, etc.) of the shape, a style (e.g., cartoon, voxelized, papercraft, game, anime, photorealistic, etc.) of the shape, one or more parts of the shape, and/or any other information associated with the shape. In some examples, the descriptions may be drafted in a specific format, such as by beginning with (e.g., triggered or otherwise initiated by) a common phrase, such as “A 3D shape of” (and/or any other phrase), followed by the details and/or information. However, in other examples, the descriptions may include any other format. Additionally, in some examples, a shape may be associated with multiple descriptions, such as a short description that summarizes the details and/or information associated with the shape and a long description that includes the details and/or information associated with the shape.

The additional data 508 may represent a format for a desired output from the language model(s) 502. For instance, and as described herein, the outputs may include multiple captions for individual shapes, such as a short caption that includes a number of words is less than a threshold number of words and a long caption that includes a number of words that is equal to or greater than the threshold number of words. As such, the additional data 508 may include text that indicates to begin the short caption, draft the short caption, end the short caption, begin the long caption, draft the long caption, and end the long caption.

In some examples, and as shown by the example of FIG. 5A, one or more of the image data 504, the description data 506, and/or the additional data 508 may initially be processed using one or more models 510 in order to generate input data 512. As described herein, the model(s) 510 may include any type of machine learning model, neural network, and/or the like that is configured to generate the input data 512 based at least on processing the image data 504, the description data 506, and/or the additional data 508. For example, the model(s) 510 may include a convolutional neural network, a feed-forward neural network, a space invariant artificial neural network, a recurrent neural network, a perceptron, a transformer, and/or any other type of network. Additionally, the input data 512 may represent a prompt that is input (e.g., applied) to the language model(s) 502. In some examples, the input data 512 may represent tokens (e.g., a tokenized representation) corresponding to the prompt, such as tokens corresponding to the images represented by the image data 504, the text represented by the description data 506, and/or the text represented by the additional data 508.

The annotation pipeline 122 may include the language model(s) 502 processing the input data 512 and, based at least on the processing, generating captions data 514 representing the captions associated with the shapes and/or the images. For example, and for a shape and/or an image, the captions data 514 may represent at least a short caption associated with the shape and/or the image and a long caption associated with the shape and/or the image. However, in other examples, the captions data 514 may represent only a single caption associated with a shape and/or an image. Additionally, in any of the examples, a caption may represent a description of a shape, such as a description that includes enough detail and/or information to reconstruct the shape.

For instance, FIG. 5B illustrates an example of generating annotations associated with a shape, in accordance with some embodiments of the present disclosure. As shown, the language model(s) 502 may receive, as input, an image 516 of the shape 208, a description 518 of the shape 208, and a format 520 for generating an output. While the example of FIG. 5B illustrates only a single description, in other examples, multiple descriptions may be input into the language model(s) 502, which are described herein. Additionally, while the example of FIG. 5B illustrates inputting the image 516, the description 518, and the format 520, in other examples, the image 516, the description 518, and/or the format 520 may initially be processed using the model(s) 510 in order to generate input data for the language model(s) 502, such as input data representing tokens.

As further illustrated by the example of FIG. 5B, based at least on processing the inputs, the language model(s) 502 may then generate an output 522 that represents at least captions associated with the shape 208. For instance, and as shown, the output 522 may represent at least a short caption and a long caption that each describe the shape 208. For example, the short caption may include a summary of a description of the shape 208 while the long caption includes the detailed description of the shape 208.

Referring back to the example of FIG. 5A, the annotation pipeline 122 may include one or more embedding elements 524 that are configured to generate embeddings associated with the captions represented by the captions data 514, where the embeddings may be represented by embeddings data 526. As described herein, the embedding element(s) 524 may include and/or use one or more machine learning models, one or more neural networks, one or more encoders, one or more transformers, and/or any other type of processing component that is configured to perform at least a portion of the processes described herein to generate the embeddings. Additionally, in some examples, such as when a shape is associated with both a short caption and a long caption, the embedding element(s) 524 may be configured to generate a first embedding associated with the short embedding and a second embedding associated with the long caption. In some examples, and again when a shape is associated with both a short caption and a long caption, the embedding element(s) 524 may be configured to generate a single embedding associated with both the short caption and the long caption.

In the example of FIG. 5A, the annotation pipeline 124 may be configured to generate and/or output the captions data 514 and/or the embeddings data 526, where the captions data 514 and/or the embeddings data 526 may represent and/or be similar to the annotation data 124 from the example of FIG. 1.

Referring back to the example of FIG. 1, the process 100 may include using a rendering pipeline 126 to generate images representing shapes, such as shapes associated with the 3D-pose data 114 (referred to as “3D shapes in these examples for clarity reasons) and/or shapes associated with the 2D-pose data 120 (referred to as “2D shapes in these examples for clarity reasons). In some examples, when rendering the shapes, the rendering pipeline 126 may be configured to render the shapes using a similar pose, such as a canonical pose. For a first example, and for the 3D shapes associated with the 3D-pose data 114, the rendering pipeline 126 may include processes for determining a canonical pose for the 3D shapes, determining intrinsic parameters associated with cameras based on the canonical pose and the determined poses from the 3D-pose data 114 (e.g., elevations and azimuth angles associated with the cameras), and then generating images that represent the 3D shapes oriented in the canonical pose using the cameras. For a second example, and for the 2D shapes associated with the 2D-pose data, the rendering pipeline 126 may include processes for determining a canonical pose, but then selecting images that represent the 2D shapes oriented in the canonical pose using the determined poses from the 2D-pose data 120.

In some examples, the rendering pipeline 126 may include performing additional processes, such as aligning the images of the 3D shapes with the images of the 2D shapes. For instance, the rendering pipeline 126 may include processes for determining updated parameters associated with cameras used to generate the images of the 2D shapes using the parameters associated with the cameras used to generate for the 3D shapes and then updating the images of the 2D shapes using the updated parameters. For examples, the updating of the images may include at least cropping the images such that the images representing the 2D shapes and the images representing the 3D shapes orient all of the shapes using the canonical pose and/or using similar dimensions. This way, even though the initial data may include both the 2D data 118 representing the 2D shapes and the 3D data 104 representing the 3D shapes, the final images represent the shapes using the same canonical pose.

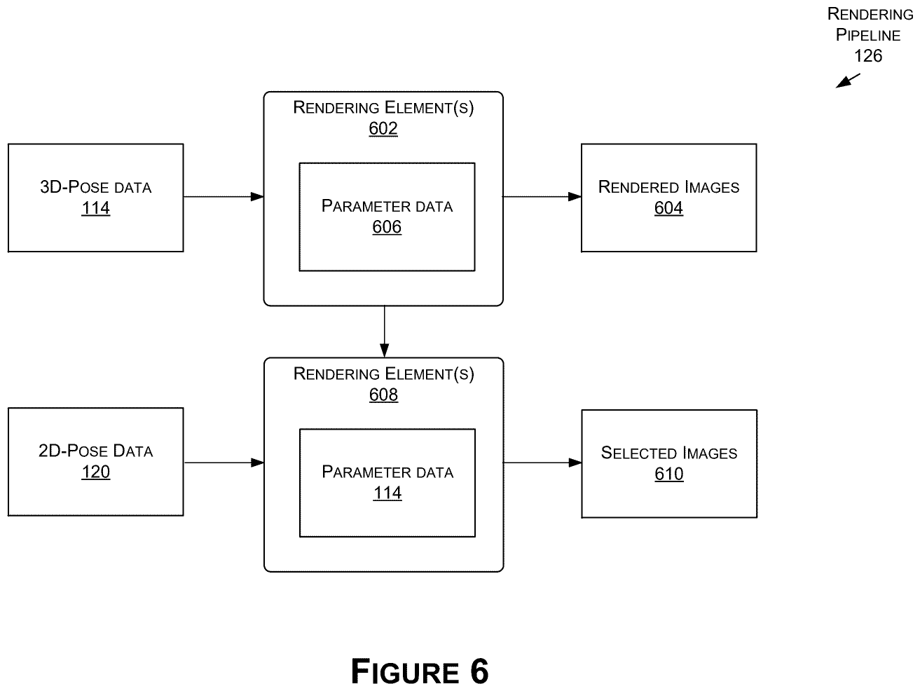

For more details of the rendering pipeline 126, FIG. 6 illustrates an example of the rendering pipeline 126 that generates images using pose data, in accordance with some embodiments of the present disclosure. As shown, one or more first rendering elements 602 may be configured to render images 604 of the 3D shapes using the pose information represented by the 3D-pose data 114. As described herein, in some examples, the first rendering element(s) 602 may determine one or more canonical poses for rendering the 3D shapes, where each canonical pose may be associated with a respective elevation of a camera and/or azimuth angle of the camera with respect to the 3D shapes as represented by parameter data 606. The first rendering element(s) 602 may then render the 3D shapes using the elevation(s) and/or the azimuth angle(s) such that the images 604 represent the 3D shapes using the canonical pose(s).

As further illustrated by the example of FIG. 6, one or more second rendering elements 608 may be configured to select images 610 of the 2D shapes using the pose information represented by the 2D-pose data 120. In some examples, such as to ensure that the selecting of the 2D shapes is consistent with the rendering of the 3D shapes, the second rendering element(s) 608 may select the 2D shapes using the same canonical pose(s) as the 3D shapes. However, since the 2D-pose data 120 represents images of the 2D shapes, but not 3D information associated with the 2D shapes, the second rendering element(s) 608 may use the parameters (e.g., the elevation(s), the azimuth angle(s), etc.) represented by the parameter data 606 to update camera parameters represented by parameter data 612. The second rendering element(s) 608 may then select the images 610 based at least on updating the original images the 2D shapes, such as by cropping the original images based on the updated camera parameters.

Referring back to the example of FIG. 1, the process 100 may include associating the annotation data 124 representing the annotations corresponding to the shapes with the image data 128 representing the images of the shapes, which is indicated by the arrow between the annotation data 124 and the image data 128. In some examples, by associating the image data 128 with the annotation data 124, the process 100 may generate a dataset that includes both images representing shapes using one or more canonical poses along with annotations of the shapes. As such, by performing the process 100, the filtering pipeline 108, the 3D-alignment pipeline 112, the 2D-alignment pipeline 116, the annotation pipeline 122, and/or the rendering pipeline 126 may be configured to perform automatic data curation and annotation. While the example of FIG. 1 illustrates the filtering pipeline 108, the 3D-alignment pipeline 112, the 2D-alignment pipeline 116, the annotation pipeline 122, and the rendering pipeline 126 as including separate pipelines, in other examples, one or more of the filtering pipeline 108, the 3D-alignment pipeline 112, the 2D-alignment pipeline 116, the annotation pipeline 122, and/or the rendering pipeline 126 may be combined into one or more pipelines.

In some examples, the process 100 may be used with respect to one or more additional technologies. For a first example, the dataset generated using the process 100, which may include the annotation data 124 and/or the image data 128, may be used by one or more systems to train one or more machine learning models to perform one or more tasks. For instance, a machine learning model may be trained to generate data representing various shapes, such as various 2D shapes and/or various 3D shapes, based on processing input data representing descriptions of the shapes. As such, to train the machine learning model, the annotations (and/or embeddings) represented by the annotation data 124 may be used as training inputs for the machine learning model while the images represented by the image data 128 may be used as the ground truth data for comparing the outputs from the machine learning model. As such, the process 100 may be used to automatically generate the training data for the machine learning model, instead of using users to generate the training data which may take large amounts of human resources and/or time.

For a second example, at least a portion of the process 100 may be used with regard to simulations and/or simulated environments, such as to check the quality of shapes that are rendered when generating the simulations and/or simulated environments. For instance, at least the filtering pipeline 108 may be used to analyze the shapes, using one or more of the processes described herein, to determine quality scores for the shapes, determine rankings for the shapes, and/or select high-quality shapes to use with regard to the simulations and/or simulated environments. As such, by performing at least a portion of the process 100, the quality of the simulations and/or simulated environments may be improved by representing more realistic shapes.

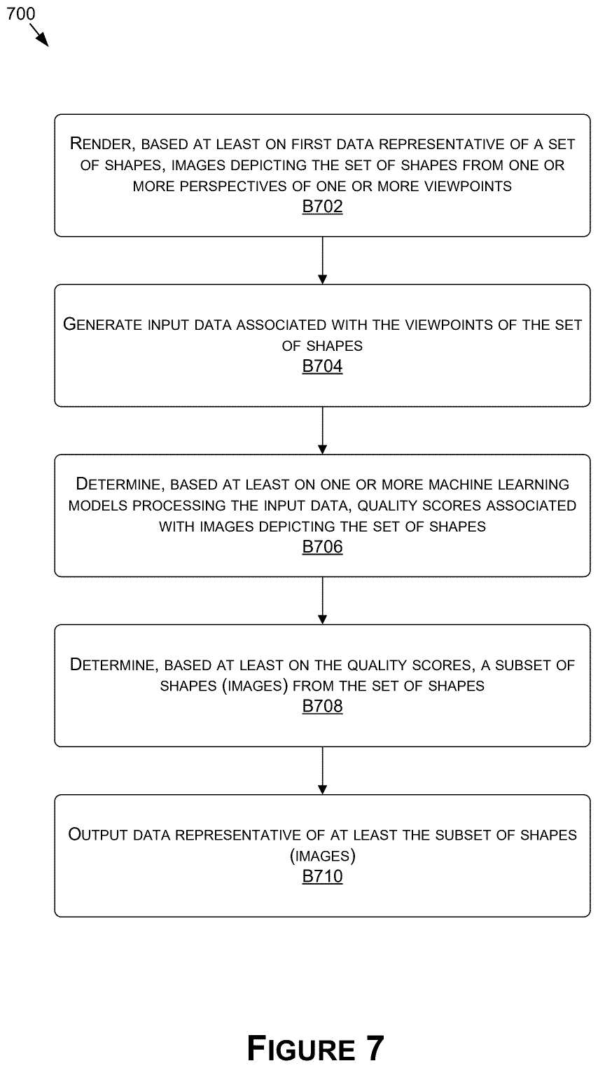

Now referring to FIGS. 7-10, each block of methods 700, 800, 900, and 1000, described herein, comprises a computing process that may be performed using any combination of hardware, firmware, and/or software. For instance, various functions may be carried out by a processor executing instructions stored in memory. The methods 700, 800, 900, and 1000 may also be embodied as computer-usable instructions stored on computer storage media. The methods 700, 800, 900, and 1000 may be provided by a standalone application, a service or hosted service (standalone or in combination with another hosted service), or a plug-in to another product, to name a few. In addition, the methods 700, 800, 900, and 1000 are described, by way of example, with respect to FIG. 1. However, these methods 700, 800, 900, and 1000 may additionally or alternatively be executed by any one system, or any combination of systems, including, but not limited to, those described herein.

FIG. 7 illustrates a flow diagram showing a method 700 for filtering images depicting shapes based at least on qualities scores associated with the shapes, in accordance with some embodiments of the present disclosure. The method 700, at block B702, may include rendering, based at least on first data representative of a set of shapes, images depicting the set of shapes from one or more perspectives of one or more viewpoints. For instance, the filtering pipeline 108 may use the 3D data 104 and/or the converted 3D data 106 to render images of the set of shapes from the perspective of the one or more views. As described herein, in some examples, an image of an individual shape may be rendered from the perspective of a number of position (viewpoints) where each viewpoint is associated with a camera being oriented at a respective angle with respect to the shape. For example, each viewpoint may be associated with the camera being located at a respective corner of a bounding shape associated with the shape and orientated towards an origin of the shape.

The method 700, at block B704, may include generating input data associated with the viewpoints of the set of shapes. For instance, the filtering pipeline 108 may generate the input data, such as input data representing one or more embeddings associated with the images depicting the viewpoints of the set of shapes. As described herein, in some examples, the filtering pipeline 108 may generate a respective embedding associated with images of each viewpoint of a shape. Additionally, or alternatively, in some examples, the filtering pipeline 108 may generate an embedding associated with all of the image(s) of the viewpoints of the shape, such as by averaging the embedding(s) associated with the view(s). In some examples, the embeddings may be associated with one or more CLIP features corresponding to the views of the set of shapes.

The method 700, at block B706, may include determining, based at least on one or more machine learning models processing the input data, quality scores associated with the images depicting the set of shapes. For instance, the filtering pipeline 108 may include the machine learning model(s) that is configured to process the input data and, based at least on the processing, determine the quality scores associated with the images depicting the set of shapes. In some examples, the filtering pipeline 108 may then rank the shapes (e.g., and corresponding images) in the set of shapes using the quality scores. For example, the filtering pipeline 108 may rank the shapes (images) from the highest-quality shape to the lowest-quality shape and/or the lowest-quality shape to the highest-quality shape using the quality scores.

The method 700, at block B708, may include determining, based at least on the quality scores, a subset of shapes (images) from the set of shapes and the method 700, at block B710, may include outputting second data representative of at least the subset of shapes (images). For instance, the filtering pipeline 108 may filter the shapes/images based at least on the quality scores and/or the rankings. As described herein, in some examples, the filtering pipeline 108 may filter the shapes/images by selecting the subset of shapes/images that are associated with one or more quality scores that satisfy a threshold score. The filtering pipeline 108 may then output the filtered 3D data 110 representing the subset of shapes/images.

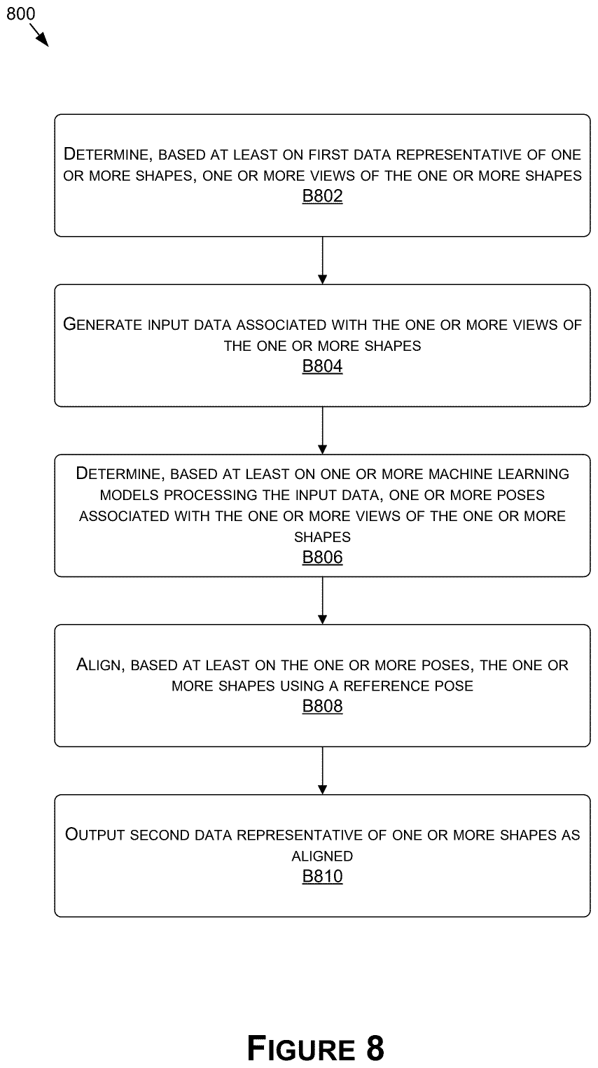

FIG. 8 illustrates a flow diagram showing a method 800 for determining poses associated with images depicting views of shapes and/or aligning the shapes based at least on the poses, in accordance with some embodiments of the present disclosure. The method 800, at block B802, may include determining, based at least on first data representative of one or more shapes, one or more views of the one or more shapes. For instance, the 3D-alignment pipeline 112 (and/or the 2D-alignment pipeline 116) may use the filtered 3D data 110 (and/or the 2D data 118) to determine the view(s) of the shape(s). As described herein, for a shape associated with the 3D data 110, the 3D-alignment pipeline 112 may determine a number of views associated with the shape, where each view is associated with a respective gravity orientation and/or a respective azimuth angle. Additionally, for a shape associated with the 2D data 118, the 2D-alignment pipeline 116 may determine a number of views associated with the shape, where each view is associated with a respective elevation and/or a respective azimuth angle.

The method 800, at block B804, may include generating input data associated with the one or more views of the one or more shapes. For instance, the 3D-alignment pipeline 112 (and/or the 2D-alignment pipeline 116) may generate the input data associated with the view(s). As described herein, in some examples, the input data may represent one or more embeddings associated with the view(s) of the shape(s). Additionally, in some examples, the embedding(s) may be associated with one or more CLIP features corresponding to the view(s) of the shape(s).

The method 800, at block B806, may include determining, based at least on one or more machine learning models processing the input data, one or more poses associated with the one or more views of the one or more shapes. For instance, the 3D-alignment pipeline 112 (and/or the 2D-alignment pipeline 116) may include the machine learning model(s) that is configured to process the input data and, based at least on the processing, determine the pose(s) associated with the view(s) of the shape(s). As described herein, for a shape associated with the 3D data 110, a pose may include a gravity orientation and/or an azimuth angle associated with the shape. Additionally, for a shape associated with the 2D data 118, a pose may include an elevation and/or an azimuth angle associated with the shape.

The method 800, at block B808, may include aligning, based at least on the one or more poses, the one or more shapes using a reference pose and the method 800, at block B810, may include outputting second data representative of the one or more shapes as aligned. For instance, the 3D-alignment pipeline 112 (and/or the 2D-alignment pipeline 116) may align the shape(s) with respect to one another using the pose(s). As described herein, in some examples, the 3D-alignment pipeline 112 (and/or the 2D-alignment pipeline 116) may align the shape(s) using the reference pose (e.g., a canonical pose). The 3D-alignment pipeline 112 (and/or the 2D-alignment pipeline 116) may then output the 3D-pose data 114 (and/or the 2D-pose data 120) representing the pose(s) associated with the shape(s) as aligned.

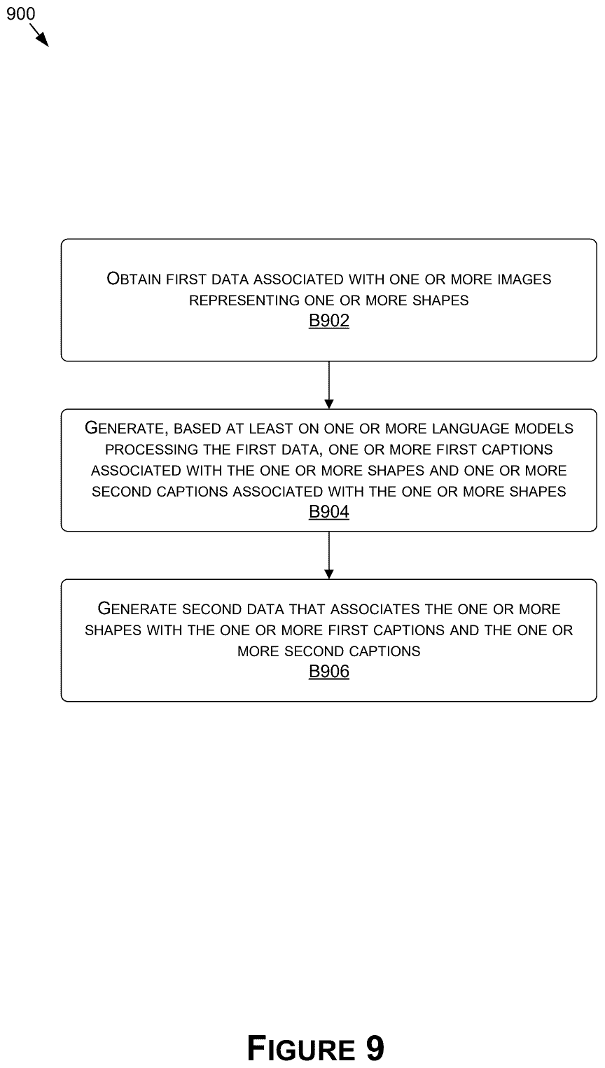

FIG. 9 illustrates a flow diagram showing a method 900 for generating annotations associated with images of shapes, in accordance with some embodiments of the present disclosure. The method 900, at block B902, may include obtaining first data associated with one or more images representing one or more shapes. For instance, the 3D-pose data 114 and/or the 2D-pose data 120 may be input into the annotation pipeline 122. The annotation pipeline 122 may then use the 3D-pose data 114 and/or the 2D-pose data 120 to generate and/or retrieve the image(s) of the shape(s). As described herein, in some examples, the annotation pipeline 122 may generate and/or retrieve the image(s) such that the shape(s) is rendered using a common pose (e.g., a canonical pose).

The method 900, at block B904, may include generating, based at least on one or more large language models processing the first data, one or more first captions associated with the one or more shapes and one or more second captions associated with the one or more shapes. For instance, the annotation pipeline 122 may include the language model(s) that processes the first data associated with the image(s) and, based at least on the processing, generates the first caption(s) and the second caption(s). As described herein, the first caption(s) may include one or more short captions that are associated with a first length and the second caption(s) may include one or more long captions that are associated with a second, longer length. Additionally, in some examples, the language model(s) may process additional data when generating the captions, such as data representing one or more descriptions of the shape(s) and/or a format for generating the captions.

The method 900, at block B906, may include generating second data that associates the one or more images with the one or more first captions and the one or more second captions. For instance, the annotation pipeline 122 may output the annotation data 124 that associates the shape(s) with the captions. As described herein, in some examples, the annotation pipeline 122 may initially generate embeddings associated with the annotations. In such examples, the annotation data 124 may then associate the shape(s) with the embeddings.

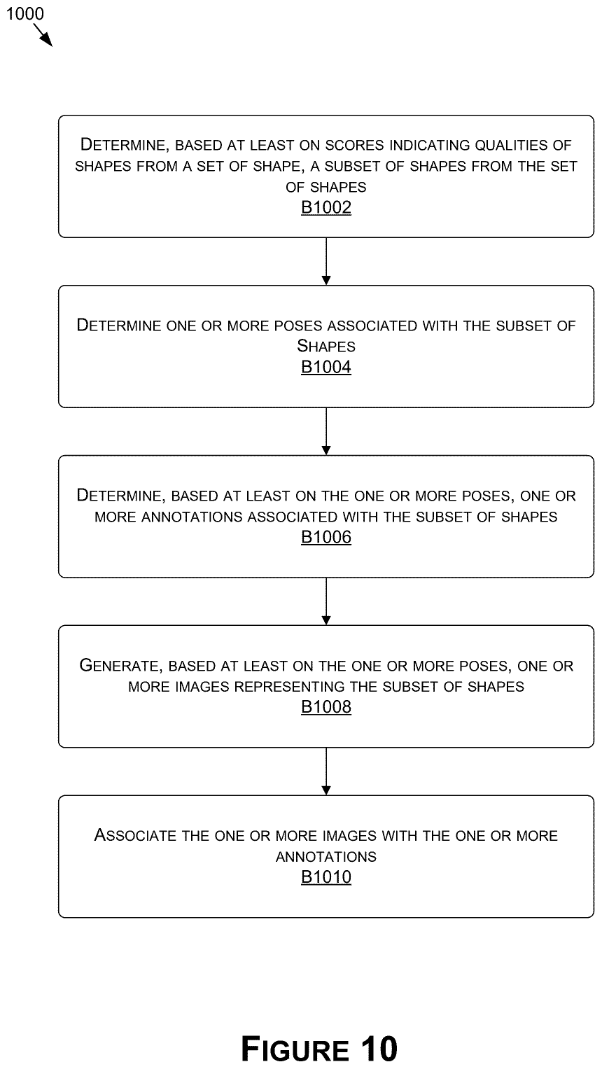

FIG. 10 illustrates a flow diagram showing a method 1000 for performing data curation and annotation, in accordance with some embodiments of the present disclosure. The method 1000, at block B1002, may include determining, based at least on scores indicating qualities of shapes from a set of shapes, a subset of shapes from the set of shapes. For instance, the filtering pipeline 108 may determine the quality scores associated with the shapes, such as by using one or more machine learning models. The filtering pipeline 108 may then filter the shapes based at least on the quality scores. For example, the filtering pipeline 108 may select one or more shapes, from the set of shapes, that are associated with one or more quality scores that satisfy a threshold score.

The method 1000, at block B1004, may include determining one or more poses associated with the subset of shapes. For instance, the 3D-alignment pipeline 112 (and/or the 2D-alignment pipeline 116) may determine the pose(s) associated with the shape(s) from the subset of shapes. As described herein, for a shape associated with the 3D data 110, a pose may indicate at least a gravity orientation and/or an azimuth angle associated with the shape. Additionally, for a shape associated with the 2D data 118, a pose may indicate an elevation and/or an azimuth angle associated with the shape.

The method 1000, at block B1006, may include determining, based at least on the one or more poses, one or more annotations associated with the subset of shapes. For instance, the annotation pipeline 122 may determine the annotation(s) associated with the shape(s) from the subset of shapes using the pose(s), such as by rendering the shape(s) using a canonical pose based on the pose(s). As described herein, in some examples, an annotation associated with a shape (image) may include at least a short caption and a long caption, where the short caption includes a number of words that is less than a threshold number of words and the long caption includes a number of words that is equal to or greater than the threshold number of words. Additionally, in some examples, the annotation pipeline 122 may generate one or more embeddings associated with the caption(s).

The method 1000, at block B1008, may include generating, based at least on the one or more poses, one or more images representing the subset of shapes and the method 1000, at block B1010, may include associating the one or more images with the one or more annotations. For instance, the rendering pipeline 126 may generate the image(s) of the shape(s) from the subset of shapes. As described herein, in some examples, the rendering pipeline 126 may generate the image(s) such that the shape(s) includes a canonical pose. Additionally, after generating the annotation(s) and/or the image(s), the annotation(s) (e.g., the embedding(s)) may be associated with the image(s).

### Example Computing Device

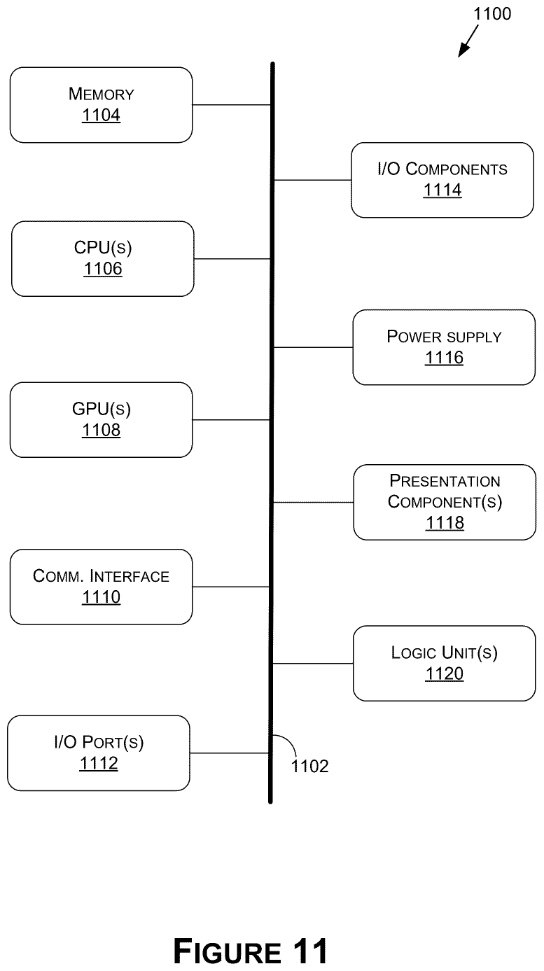

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

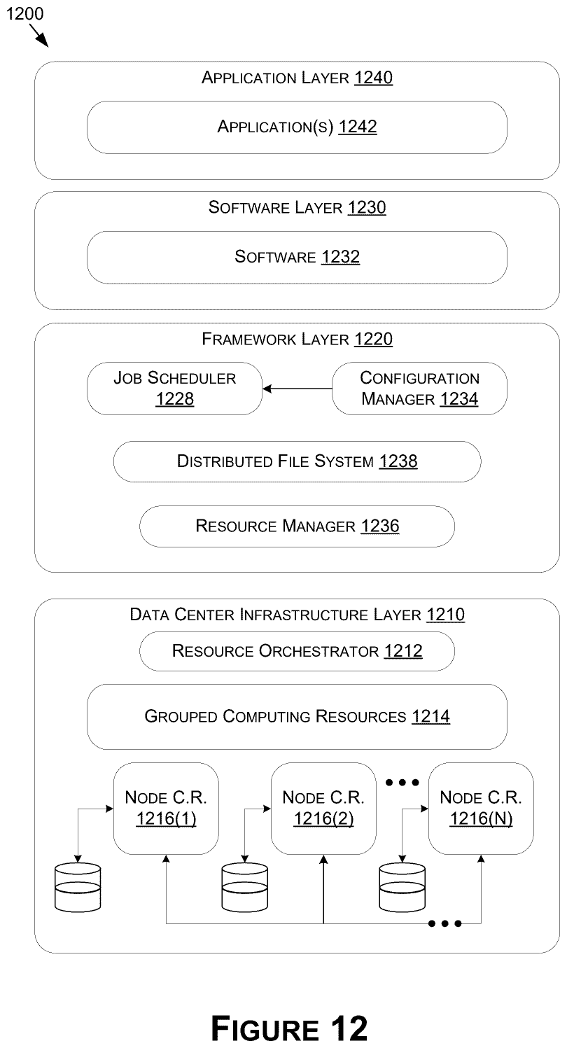

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. patent application Ser. No. 18/304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

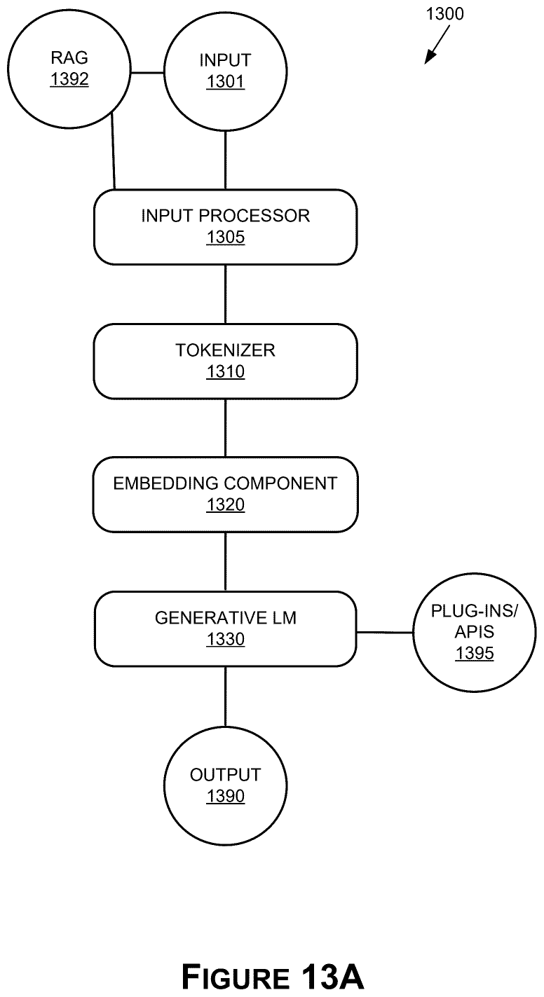

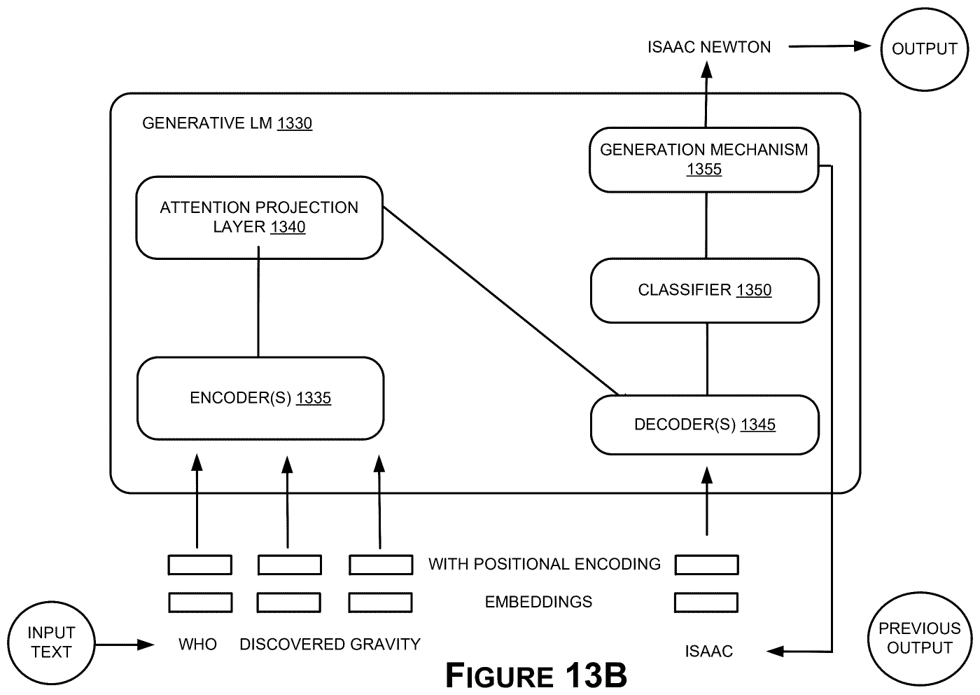

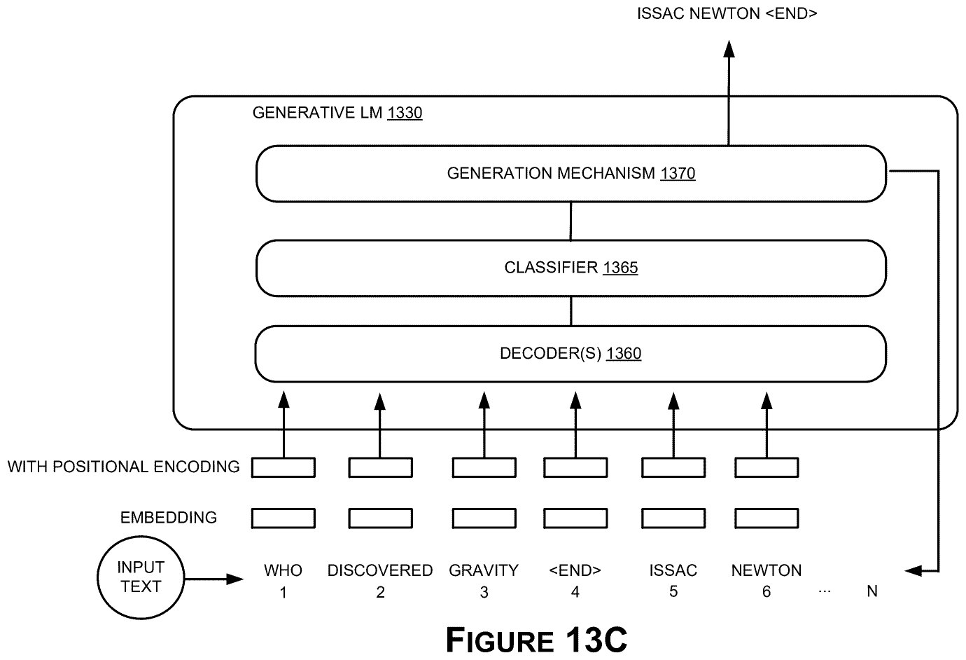

FIG. 13A is a block diagram of an example generative language model system 1300 suitable for use in implementing at least some embodiments of the present disclosure. In the example illustrated in FIG. 13A, the generative language model system 1300 includes a retrieval augmented generation (RAG) component 1392, an input processor 1305, a tokenizer 1310, an embedding component 1320, plug-ins/APIs 1395, and a generative language model (LM) 1330 (which may include an LLM, a VLM, a multi-modal LM, etc.).

At a high level, the input processor 1305 may receive an input 1301 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1330. In some embodiments, the input 1301 includes plain text in the form of one or more sentences, paragraphs, and/or documents. Additionally or alternatively, the input 1301 may include numerical sequences, precomputed embeddings (e.g., word or sentence embeddings), and/or structured data (e.g., in tabular formats, JSON, or XML). In some implementations in which the generative LM 1330 is capable of processing multimodal inputs, the input 1301 may combine text with image data, audio data, and/or other types of input data, such as but not limited to those described herein. Taking raw input text as an example, the input processor 1305 may prepare raw input text in various ways. For example, the input processor 1305 may perform various types of text cleaning to remove noise (e.g., special characters, punctuation, HTML tags, stopwords) from relevant textual content. In an example involving stopwords (common words that tend to carry little semantic meaning), the input processor 1305 may remove stopwords to reduce noise and focus the generative LM 1330 on more meaningful content. The input processor 1305 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1392 may be used to retrieve additional information to be used as part of the input 1301 or prompt. For example, in some embodiments, the input 1301 may be generated using the query or input to the model (e.g., a question, a request, etc.) in addition to data retrieved using the RAG component 1392. In some embodiments, the input processor 1305 may analyze the input 1301 and communicate with the RAG component 1392 (or the RAG component 1392 may be part of the input processor 1305, in embodiments) in order to identify relevant text and/or other data to provide to the generative LM 1330 as additional context or sources of information from which to identify the response, answer, or output 1390, generally. For example, where the input indicates that the user is interested in a desired tire pressure for a particular make and model of vehicle, the RAG component 1392 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1392 may retrieve a prior stored conversation history—or at least a summary thereof—and include the prior conversation history along with the current ask/request as part of the input 1301 to the generative LM 1330.

The tokenizer 1310 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1330 to understand morphological variations and handle out-of-vocabulary words more effectively. Character-based tokenization represents each character as a separate token, enabling the generative LM 1330 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1320 may use any known embedding technique to transform discrete tokens into (e.g., dense, continuous vector) representations of semantic meaning. For example, the embedding component 1320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1301 includes image data, the input processor 1301 may resize the image data to a standard size compatible with format of a corresponding input channel and/or may normalize pixel values to a common range (e.g., 0 to 1) to ensure a consistent representation, and the embedding component 1320 may encode the image data using any known technique (e.g., using one or more convolutional neural networks (CNNs) to extract visual features). In some implementations in which the input 1301 includes audio data, the input processor 1301 may resample an audio file to a consistent sampling rate for uniform processing, and the embedding component 1320 may use any known technique to extract and encode audio features—such as in the form of a spectrogram (e.g., a mel-spectrogram). In some implementations in which the input 1301 includes video data, the input processor 1301 may extract frames or apply resizing to extracted frames, and the embedding component 1320 may extract features such as optical flow embeddings or video embeddings and/or may encode temporal information or sequences of frames. In some implementations in which the input 1301 includes multimodal data, the embedding component 1320 may fuse representations of the different types of data (e.g., text, image, audio) using techniques like early fusion (concatenation), late fusion (sequential processing), attention-based fusion, etc.

The generative LM 1330 and/or other components of the generative LLM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1320 may apply an encoded representation of the input 1301 to the generative LM 1330, and the generative LM 1330 may process the encoded representation of the input 1301 to generate an output 1390, which may include responsive text and/or other types of data.

As described herein, in some embodiments, the generative LM 1330 may be configured to access or use—or capable of accessing or using—plug-ins/APIs 1395 (which may include one or more plug-ins, application programming interfaces (APIs), databases, data stores, repositories, etc.). For example, for certain tasks or operations that the generative LM 1330 is not ideally suited for, the model may have instructions (e.g., as a result of training, and/or based on instructions in a given prompt, such as those retrieved using the RAG component 1392) to access one or more plug-ins/APIs 1395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1395 to the plug-in/API 1395, the plug-in/API 1395 may process the information and return an answer to the generative LM 1330, and the generative LM 1330 may use the response to generate the output 1390. This process may be repeated—e.g., recursively—for any number of iterations and using any number of plug-ins/APIs 1395 until an output 1390 that addresses each ask/question/request/process/operation/etc from the input 1301 can be generated. As such, the model(s) may not only rely on its own knowledge from training on a large dataset(s) and/or from data retrieved using the RAG component 1392, but also on the expertise or optimized nature of one or more external resources—such as the plug-ins/APIs 1395.

FIG. 13B is a block diagram of an example implementation in which the generative LM 1330 includes a transformer encoder-decoder. For example, assume input text such as “Who discovered gravity” is tokenized (e.g., by the tokenizer 1310 of FIG. 13A) into tokens such as words, and each token is encoded (e.g., by the embedding component 1320 of FIG. 913A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1335 of the generative LM 1330.

In an example implementation, the encoder(s) 1335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1340 may convert the context vector into attention vectors (keys and values) for the decoder(s) 1345.

In an example implementation, the decoder(s) 1345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1335, in an example transformer architecture, each token (e.g., word) flows through a separate path in the decoder(s) 1345. During a first pass, the decoder(s) 1345, a classifier 1350, and a generation mechanism 1355 may generate a first token, and the generation mechanism 1355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1335, except that it creates its queries from the layer below it and takes the keys and values (e.g., matrix) from the output of the encoder(s) 1335.

As such, the decoder(s) 1345 may output some decoded (e.g., vector) representation of the input being applied during a particular pass. The classifier 1350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1355 may select or sample a word or token based on a corresponding predicted probability (e.g., select the word with the highest predicted probability) and append it to the output from a previous pass, generating each word or token sequentially. The generation mechanism 1355 may repeat the process, triggering successive decoder inputs and corresponding predictions until selecting or sampling a symbol or token that represents the end of the response, at which point, the generation mechanism 1355 may output the generated response.

FIG. 13C is a block diagram of an example implementation in which the generative LM 1330 includes a decoder-only transformer architecture. For example, the decoder(s) 1360 of FIG. 13C may operate similarly as the decoder(s) 1345 of FIG. 13B except each of the decoder(s) 1360 of FIG. 13C omits the encoder-decoder self-attention layer (since there is no encoder in this implementation). As such, the decoder(s) 1360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1360. As with the decoder(s) 1345 of FIG. 13B, each token (e.g., word) may flow through a separate path in the decoder(s) 1360, and the decoder(s) 1360, a classifier 1365, and a generation mechanism 1370 may use auto-regression to sequentially generate one token at a time until predicting a symbol or token that represents the end of the response. The classifier 1365 and the generation mechanism 1370 may operate similarly as the classifier 1350 and the generation mechanism 1355 of FIG. 13B, with the generation mechanism 1370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Paragraphs

A: A method comprising: rendering, based at least on first data representative of a set shapes in a 3D scene, a set of images depicting the set of shapes from one or more viewpoints in the 3D scene; generating embeddings associated with the viewpoints of the set of shapes as depicted in the set of images; determining, based at least on one or more machine learning models processing the embeddings, scores corresponding to one or more quality metrics associated with the set of images depicting the set of shapes; determining a subset of images from the set of images based at least on the scores; and outputting second data representative of the subset of images.

B: The method of paragraph A, wherein the rendering the set of shapes comprises rendering, based at least on the first data, the set of images depicting the set of shapes using at least: first viewpoints that represent the set of shapes from one or more first angles at one or more first positions in the 3D scene with respect to the set of shapes; and second viewpoints that represent the set of shapes from one or more second angles at one or more second positions in the 3D scene with respect to the set of shapes.

C: The method of paragraph B, wherein: the generating the embeddings associated with the viewpoints of the set of shapes comprises: generating first embeddings associated with the first viewpoints; generating second embeddings associated with the second viewpoints; and generating third embeddings based at least on the first embeddings and the second embeddings; and the determining the scores corresponding to the one or more quality metrics associated with the images depicting the set of shapes is based at least on the one or more machine learning models processing the third embeddings.

D: The method of any one of paragraphs A-C, wherein the determining the subset of images comprises: determining, from the set of images depicting the set of shapes, one or more images depicting one or more shapes that are associated with one or more scores from the scores that satisfy a threshold score; and determining the subset of images to include at least the one or more images.

E: The method of paragraph D, further comprising: determining a scoring distribution associated with the scores; and determining the threshold score based at least on the scoring distribution.

F: The method of any one of paragraphs A-E, wherein the determining the subset of images comprises: determining, based at least on the scores, an initial subset of images by removing one or more first images from the set of images; and determining, based at least on one or more rules indicating one or more second quality metrics, the subset of images by removing one or more second images from the initial subset of images.

G: The method of paragraph F, wherein the one or more rules indicating the one or more second quality metrics include at least one of: a first rule to remove corrupted images; a second rule to remove images associated with large scenes; a third rule to remove images associated with scenes that depict multiple shapes; a fourth rule to remove images that depict ground planes; or a fifth rule to remove images that depict backdrops.

H: The method of any one of paragraphs A-G, further comprising: obtaining training data representative of a training set of images and ground truth data representative of ground truth scores associated with the training set of images; generating second embeddings associated with the training set of images; determining, based at least on the one or more machine learning models processing the second embeddings, second scores associated with the training set of images; and updating one or more parameters associated with the one or more machine learning models based at least on the second scores and the ground truth scores.

I: The method of any one of paragraphs A-H, further comprising: selecting, based at least on the scores, one or more images from the set of images; determining one or more updated scores associated with the one or more images; and training the one or more machine learning models using at least the one or more images and the one or more updated scores.

J: A system comprising: one or more processors to: determine, based at least on first data representative of a set of three-dimensional (3D) shapes, one or more viewpoints of the set of shapes; determine, using one or more machine learning models and based at least on the viewpoints, one or more quality scores associated with the set of shapes; determine, based at least on the one or more quality score, a subset of shapes from the set of shapes; and output second data representative of at least the subset of shapes.

K: The system of paragraph J, wherein the determination of the one or more viewpoints of the set of shapes comprises determining, based at least on the first data, at least: one or more first viewpoints that represent the set of shapes from one or more first angles with respect to the set of shapes; and one or more second viewpoints that represents the set of shapes from one or more second angles with respect to the set of shapes.

L: The system of paragraph J or paragraph K, wherein the one or more processors are further to: determine one or more embeddings associated with the one or more viewpoints of the set of shapes, wherein the determination of the quality scores associated with the set of shapes is based at least on the one or more machine learning models processing the one or more embeddings.

M: The system of any one of paragraphs J-L, wherein the one or more processors are further to: determine one or more first embeddings associated with a first portion of the one or more viewpoints of the set of shapes, the first portion of the one or more viewpoints being associated with one or more first angles of the set of shapes; determine one or more second embeddings associated with a second portion of the one or more viewpoints of the set of shapes, the second portion of the one or more viewpoints being associated with one or more second angles of the shapes; and determine one or more third embeddings based at least on the one or more first embeddings with the one or more second embeddings, wherein the determination of the quality scores associated with the set of shapes is based at least on the one or more machine learning models processing the one or more third embeddings.

N: The system of any one of paragraphs J-M, wherein the determination of the subset of shapes from the set of shapes comprises: determining, from the set of shapes, one or more shapes that are associated with the one or more quality scores that satisfy a threshold quality score; and determining the subset of shapes to include at least the one or more shapes.

O: The system of any one of paragraphs J-N, wherein the determination of the subset of shapes from the set of shapes comprises: determining, based at least on the one or more quality scores, an initial subset of shapes by removing one or more first shapes from the set of shapes; and determining, based at least on one or more rules indicating one or more quality metrices, the subset of shapes by removing one or more second shapes from the initial subset of shapes.

P: The system of any one of paragraphs J-O, wherein the one or more processors are further to: obtain training data representative of a training set of shapes and ground truth data representative of one or more ground truth quality scores associated with the training set of shapes; determine, using the one or more machine learning models and based at least on the training set of shapes, one or more second quality scores associated with the training set of shapes; and update one or more parameters associated with the one or more machine learning models based at least on the one or more second quality scores and the one or more ground truth quality scores.

Q: The system of any one of paragraphs J-P, wherein the one or more processors are further to: select, based at least on the one or more quality scores, one or more shapes from the set of shapes; determine one or more updated quality scores associated with the one or more shapes; and train the one or more machine learning models based at least on the one or more shapes and the one or more updated quality scores.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to determine a subset of images depicting three-dimensional (3D) shapes from a set of images based at least on scores indicating one or more quality metrics associated with the set of images, wherein the scores are determined based at least on one or more machine learning models processing embeddings associated with multiple views of the 3D shapes depicted in the set of images.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

U: A method comprising: determining, based at least on first data representative of one or more shapes, one or more images depicting one or more views of the one or more shapes; generating one or more embeddings associated with the one or more views of the one or more shapes; determining, based at least on one or more machine learning models processing the one or more embeddings, one or more poses associated with the one or more views; aligning, based at least on the one or more poses, the one or more shapes using a reference pose; and outputting second data representative of the one or more shapes as aligned.

V: The method of paragraph U, wherein: the first data represents three-dimensional information associated with the one or more shapes; and the determining the one or more views of the one or more shapes comprises rendering, based at least on the first data representative of the one or more shapes, the one or more images depicting the one or more views of the one or more shapes using one or more gravity orientations and one or more azimuth angles.

W: The method of either paragraph U or paragraph V, wherein: the first data represents two-dimensional information associated with the one or more shapes; and the determining the one or more images of the one or more views of the one or more shapes comprises determining, based at least on the first data representative of the one or more shapes, one or more images that represent the one or more shapes at an elevation and using one or more azimuth angles.

X: The method of any one of paragraphs U-W, wherein: the first data represents three-dimensional information associated with the one or more shapes; and the determining the one or more poses associated with the one or more views of the one or more shapes comprises determining, based at least on the one or more machine learning models processing the one or more embeddings, one or more gravity orientations and one or more azimuth angles associated with the one or more views of the one or more shapes.

Y: The method of any one of paragraphs U-X, wherein: the first data represents two-dimensional information associated with the one or more shapes; and the determining the one or more poses associated with the one or more views of the one or more shapes comprises determining, based at least on the one or more machine learning models processing the one or more embeddings, at least one of one or more elevations or one or more azimuth angles associated with the one or more views of the set of shapes.

Z: The method of any one of paragraphs U-Y, wherein: the one or more shapes include a set of shapes; the method further comprises determining, based at least on one or more rules associated with one or more quality metrices, a subset of shapes from the set of shapes; and the one or more poses are associated with the subset of shapes.

AA: The method of any one of paragraphs U-Z, wherein the aligning the one or more shapes comprises: determining the reference pose; and determining, based at least on the one or more poses, one or more images that represent the one or more shapes in the reference pose.

AB: The method of any one of paragraphs U-AA, further comprising: obtaining training data representative of one or more training images depicting views of one or more second shapes and ground truth data representative of one or more ground truth poses associated with the views depicted by the one or more training images; generating one or more second embeddings associated with the one or more training views; determining, based at least on the one or more machine learning models processing the one or more second embeddings, one or more second poses associated with the one or more training views; and updating one or more parameters associated with the one or more machine learning models based at least on the one or more second poses and the one or more ground truth poses.

AC: The method of any one of paragraphs U-AB, further comprising: selecting, based at least on the one or more poses, at least a shape from the one or more shapes; determining an updated pose associated with the shape; and training the one or more machine learning models based at least on the shape and the updated pose.

AD: A system comprising: one or more processor to: determine, based at least on first data representative of one or more shapes, images depicting one or more views of the one or more shapes; determine, using one or more machine learning models and based at least on the images depicting the one or more views of the one or more shapes, one or more poses associated with the one or more views; and output data representative of at least the one or more poses associated with the one or more views.

AE: The system of paragraph AD, wherein the one or more processors are further to: align the one or more views of the one or more shapes based at least on the one or more poses, wherein the second data further represents the one or more views as aligned.

AF: The system of either paragraph AD or paragraph AE, wherein the one or more processors are further to: generate one or more embeddings associated with the images depicting the one or more views of the one or more shapes, wherein the determination of the one or more poses is based at least on the one or more machine learning models processing the one or more embeddings.

AG: The system of any one of paragraphs AD-AF, wherein: the first data represents three-dimensional information associated with the one or more shapes; and the determination of the images depicting the one or more views of the one or more shapes comprises rendering, based at least on the first data representative of the one or more shapes, images depicting the one or more views of the one or more shapes using one or more gravity orientations and one or more azimuth angles.

AH: The system of any one of paragraphs AD-AG, wherein: the first data represents two-dimensional information associated with the one or more shapes; and the determination of the images depicting the one or more views of the one or more shapes comprises determining, based at least on the first data representative of the one or more shapes, one or more images that represent the one or more shapes at an elevation and using one or more azimuth angles.

AI: The system of any one of paragraphs AD-AH, wherein: the first data represents three-dimensional information associated with the one or more shapes; and the determination of the one or more poses associated with the one or more views of the one or more shapes comprises determining, using the one or more machine learning models and based at least on the one or more views of the one or more shapes, one or more gravity orientations and one or more azimuth angles associated with the one or more views.

AJ: The system of any one of paragraphs AD-AI, wherein: the first data represents two-dimensional information associated with the one or more shapes; and the determination of the one or more poses associated with the one or more views of the one or more shapes comprises determining, using the one or more machine learning models and based at least on the one or more views of the one or more shapes, at least one of one or more elevations or one or more azimuth angles associated with the one or more views.

AK: The system of any one of paragraphs AD-AJ, wherein the one or more processors are further to: obtain training data representative of one or more training images depicting views of one or more second shapes and ground truth data representative of one or more ground truth poses associated with the one or more training images; determine, using the one or more machine learning models and based at least on the one or more second views, one or more second poses associated with the one or more second views; and updating one or more parameters associated with the one or more machine learning models based at least on the one or more second poses and the one or more ground truth poses.

AL The system of any one of paragraphs AD-AK, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

AM: One or more processors comprising: processing circuitry to align one or more shapes with respect to a reference pose based at least on one or more poses associated with the one or more shapes, wherein the one or more poses are determined based at least on one or more machine learning models processing one or more embeddings associated with one or more views of the one or more shapes.

AN: The one or more processors of paragraph AM, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

AO: A method comprising: generating, based at least on one or more language models processing first data associated with one or more images depicting one or more shapes: one or more first captions describing the one or more shapes, the one or more first captions associated with one or more first numbers of words that are less than a threshold number of words; and one or more second captions describing the one or more shapes, the one or more second captions being associated with one or more second numbers of words that are equal to or greater than the threshold number of words; and generating second data that associates the one or more shapes with the one or more first captions and the one or more second captions.

AP: The method of paragraph AO, further comprising: generating one or more first embeddings associated with the one or more first captions and one or more second embeddings associated with the one or more second captions, wherein the second data associates the one or more shapes with the one or more first embeddings and the one or more second embeddings.

AQ: The method of either paragraph AO or paragraph AP, further comprising: generating one or more embeddings associated with one or more combinations of the one or more first captions and the one or more second captions, wherein the second data associates the one or more shapes with the one or more embeddings.

AR: The method of any one of paragraphs AO-AQ, wherein the generating the one or more first captions and the one or more second captions is further based at least on the one or more machine learning models processing third data representative of one or more descriptions associated with the one or more shapes.

AS: The method of paragraph AR, wherein the one or more descriptions may include at least one of: one or more categories associated with the one or more shapes; or one or more tags indicating one or more characteristics associated with the one or more shapes.

AT: The method of any one of paragraphs AO-AS, wherein the generating the one or more first captions and the one or more second captions is further based at least on the one or more machine learning models processing third data representative of an output format, the output format associated with generating both the one or more first captions and the one or more second captions for the one or more shapes.

AU: The method of any one of paragraphs AO-AT, further comprising: generating, based at least on image data representative of the one or more images, one or more input tokens, wherein the first data represents the one or more input tokens.

AV: The method of any one of paragraphs AO-AU, further comprising: receiving third data representative of one or more poses associated with the one or more shapes; and generating, based at least on the one or more poses, the one or more images to represent the one or more shapes from the perspective of a canonical viewpoint.

AW: The method of paragraph AV, further comprising three-dimensional information associated with a first portion of the one or more shapes and two-dimensional information associated with a second portion of the one or more shapes, and wherein the generating the one or more images comprises: generating one or more first images based at least on the one or more poses, the three-dimensional information, and one or more first camera parameters, the one or more first images depicting the first portion of the one or more shapes from the canonical viewpoint; determining, based at least on the one or more first camera parameters, one or more second parameters for rendering the one or more shapes; and generating, based at least on the two-dimensional information and the one or more second camera parameters, one or more second images that depict the second portion of the one or more shapes from the canonical viewpoint.

AX: A system comprising: one or more processors to: generate, using one or more language models and based at least on first data associated with one or more images of one or more objects: one or more first captions associated with the one or more shapes, the one or more first captions being associated with one or more first lengths; and one or more second captions associated with the one or more shapes, the one or more second captions being associated with one or more second lengths that is different than the one or more first lengths; and generate second data that associates the one or more images with the one or more first captions and the one or more second captions.

AY: The system of paragraph AX, wherein the one or more processors are further to: generate one or more first embeddings associated with the one or more first captions and one or more second embeddings associated with the one or more second captions, wherein the second data associates the one or more shapes with the one or more first embeddings and the one or more second embeddings.

AZ: The system of either paragraph AX or paragraph AY, wherein the one or more processors are further to: generate one or more embeddings associated with one or more combinations of the one or more first captions and the one or more second captions, wherein the second data associates the one or more shapes with the one or more embeddings.

BA: The system of any one of paragraphs AX-AZ, wherein the generation of the one or more first captions and the one or more second captions is further based at least on the one or more machine learning models processing third data representative of one or more descriptions associated with the one or more shapes.

BB: The system of any one of paragraphs AX-BA, wherein the generation of the one or more first captions and the one or more second captions is further based at least on the one or more machine learning models processing third data representative of an output format, the output format associated with generating both the one or more first captions and the one or more second captions for the one or more shapes.

BC: The system of any one of paragraphs AX-BB, wherein: the one or more first lengths are associated with one or more first numbers of words that are less than a threshold number of words; and the one or more second lengths are associated with one or more second numbers of words that are equal to or greater than the threshold number of words.

BD: The system of any one of paragraphs AX-BC, wherein the one or more processors are further to: receive third data representative of one or more poses associated with the one or more shapes; and generate, based at least on the one or more poses, the one or more images to represent the one or more shapes from a canonical viewpoint.

BE: The system of paragraph BD, wherein the one or more processors are further to obtain three-dimensional information associated with a first portion of the one or more shapes and two-dimensional information associated with a second portion of the one or more shapes, and wherein the generation of the one or more images comprises: generating one or more first images based at least on the one or more poses, the three-dimensional information, and one or more first camera parameters, the one or more first images depicting the first portion of the one or more shapes from the canonical viewpoint; determining, based at least on the one or more first camera parameters, one or more second parameters for rendering the one or more shapes; and generating, based at least on the two-dimensional information and the one or more second camera parameters, one or more second images that represent the one or more shapes from the canonical viewpoint.

BF: The system of any one of paragraphs AX-BE, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

BG: One or more processors comprising: processing circuitry to associate one or more shapes with one or more first captions that are associated with a first length and one or more second captions that are associated with a second length, wherein the one or more first captions and the one or more second captions are determined based at least on one or more language models processing data associated with one or more images depicting the one or more shapes.

BH: The one or more processors of paragraph BG, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
rendering, based at least on first data representative of a set shapes in a 3D scene, a set of images depicting the set of shapes from one or more viewpoints in the 3D scene;
generating embeddings associated with the viewpoints of the set of shapes as depicted in the set of images;
determining, based at least on one or more machine learning models processing the embeddings, scores corresponding to one or more quality metrics associated with the set of images depicting the set of shapes;
determining a subset of images from the set of images based at least on the scores; and
outputting second data representative of the subset of images.

2. The method of claim 1, wherein the rendering the set of shapes comprises rendering, based at least on the first data, the set of images depicting the set of shapes using at least:
first viewpoints that represent the set of shapes from one or more first angles at one or more first positions in the 3D scene with respect to the set of shapes; and
second viewpoints that represent the set of shapes from one or more second angles at one or more second positions in the 3D scene with respect to the set of shapes.

3. The method of claim 2, wherein:
the generating the embeddings associated with the viewpoints of the set of shapes comprises:
generating first embeddings associated with the first viewpoints;
generating second embeddings associated with the second viewpoints; and
generating third embeddings based at least on the first embeddings and the second embeddings; and
the determining the scores corresponding to the one or more quality metrics associated with the images depicting the set of shapes is based at least on the one or more machine learning models processing the third embeddings.

4. The method of claim 1, wherein the determining the subset of images comprises:
determining, from the set of images depicting the set of shapes, one or more images depicting one or more shapes that are associated with one or more scores from the scores that satisfy a threshold score; and
determining the subset of images to include at least the one or more images.

5. The method of claim 4, further comprising:
determining a scoring distribution associated with the scores; and
determining the threshold score based at least on the scoring distribution.

6. The method of claim 1, wherein the determining the subset of images comprises:
determining, based at least on the scores, an initial subset of images by removing one or more first images from the set of images; and
determining, based at least on one or more rules indicating one or more second quality metrics, the subset of images by removing one or more second images from the initial subset of images.

7. The method of claim 6, wherein the one or more rules indicating the one or more second quality metrics include at least one of:
a first rule to remove corrupted images;
a second rule to remove images associated with large scenes;
a third rule to remove images associated with scenes that depict multiple shapes;
a fourth rule to remove images that depict ground planes; or
a fifth rule to remove images that depict backdrops.

8. The method of claim 1, further comprising:
obtaining training data representative of a training set of images and ground truth data representative of ground truth scores associated with the training set of images;
generating second embeddings associated with the training set of images;
determining, based at least on the one or more machine learning models processing the second embeddings, second scores associated with the training set of images; and
updating one or more parameters associated with the one or more machine learning models based at least on the second scores and the ground truth scores.

9. The method of claim 1, further comprising:
selecting, based at least on the scores, one or more images from the set of images;
determining one or more updated scores associated with the one or more images; and
training the one or more machine learning models using at least the one or more images and the one or more updated scores.

10. A system comprising:
one or more processors to:
determine, based at least on first data representative of a set of three-dimensional (3D) shapes, one or more viewpoints of the set of shapes;
determine, using one or more machine learning models and based at least on the viewpoints, one or more quality scores associated with the set of shapes;
determine, based at least on the one or more quality score, a subset of shapes from the set of shapes; and
output second data representative of at least the subset of shapes.

11. The system of claim 10, wherein the determination of the one or more viewpoints of the set of shapes comprises determining, based at least on the first data, at least:
one or more first viewpoints that represent the set of shapes from one or more first angles with respect to the set of shapes; and
one or more second viewpoints that represents the set of shapes from one or more second angles with respect to the set of shapes.

12. The system of claim 10, wherein the one or more processors are further to:
determine one or more embeddings associated with the one or more viewpoints of the set of shapes,
wherein the determination of the quality scores associated with the set of shapes is based at least on the one or more machine learning models processing the one or more embeddings.

13. The system of claim 10, wherein the one or more processors are further to:
determine one or more first embeddings associated with a first portion of the one or more viewpoints of the set of shapes, the first portion of the one or more viewpoints being associated with one or more first angles of the set of shapes;
determine one or more second embeddings associated with a second portion of the one or more viewpoints of the set of shapes, the second portion of the one or more viewpoints being associated with one or more second angles of the shapes; and
determine one or more third embeddings based at least on the one or more first embeddings with the one or more second embeddings,
wherein the determination of the quality scores associated with the set of shapes is based at least on the one or more machine learning models processing the one or more third embeddings.

14. The system of claim 10, wherein the determination of the subset of shapes from the set of shapes comprises:
determining, from the set of shapes, one or more shapes that are associated with the one or more quality scores that satisfy a threshold quality score; and
determining the subset of shapes to include at least the one or more shapes.

15. The system of claim 10, wherein the determination of the subset of shapes from the set of shapes comprises:
determining, based at least on the one or more quality scores, an initial subset of shapes by removing one or more first shapes from the set of shapes; and
determining, based at least on one or more rules indicating one or more quality metrices, the subset of shapes by removing one or more second shapes from the initial subset of shapes.

16. The system of claim 10, wherein the one or more processors are further to:
obtain training data representative of a training set of shapes and ground truth data representative of one or more ground truth quality scores associated with the training set of shapes;
determine, using the one or more machine learning models and based at least on the training set of shapes, one or more second quality scores associated with the training set of shapes; and
update one or more parameters associated with the one or more machine learning models based at least on the one or more second quality scores and the one or more ground truth quality scores.

17. The system of claim 10, wherein the one or more processors are further to:
select, based at least on the one or more quality scores, one or more shapes from the set of shapes;
determine one or more updated quality scores associated with the one or more shapes; and
train the one or more machine learning models based at least on the one or more shapes and the one or more updated quality scores.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to determine a subset of images depicting three-dimensional (3D) shapes from a set of images based at least on scores indicating one or more quality metrics associated with the set of images, wherein the scores are determined based at least on one or more machine learning models processing embeddings associated with multiple views of the 3D shapes depicted in the set of images.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
